(19) United States
(12) Patent Application Publication
(10) Pub. No.: US 2025/0291311 A1
(43) Pub. Date: Sep. 18, 2025

(54) IMAGE FORMING APPARATUS

(71) Applicant: CANON KABUSHIKI KAISHA, Tokyo (JP)

(72) Inventor: YOJI MISAO, Shizuoka (JP)

(21) Appl. No.: 19/074,992

(22) Filed: Mar. 10, 2025

(30) Foreign Application Priority Data
Mar. 12, 2024 (JP) 2024-037893

(51) Int. Cl. G03G 21/18; G03G 15/00; G03G 15/16; G03G 15/20; G03G 21/16

(52) U.S. Cl. CPC G03G 21/1842; G03G 15/161; G03G 15/2017; G03G 15/6502; G03G 15/657; G03G 15/751; G03G 21/1633; G03G 21/1647

(57) ABSTRACT

An image forming apparatus includes an apparatus main body including an opening; a first unit; a second unit including an engaged portion, and is configured to be movable from the apparatus main body together with the first unit, and also to be movable from the apparatus main body independently from the first unit; and an engaging member which is engaged with the engaged portion in a case where the second unit is moved out from the apparatus main unit body, the engaging member including a first path and a second path branching from the first path. In a case where the second unit is moved out together with the first unit, the engaged portion passes the first path, and in a case where the second unit is moved out independently from the first unit, the engaged portion passes the second path.

### BACKGROUND

### Field

The present disclosure relates to an image forming apparatus.

### Description of the Related Art

As an image forming apparatus such as a printer, a copier, and a multifunction machine, a configuration is known, which includes a tray configured to be movable between the inside and outside of a main body of the image forming apparatus, and a cartridge which is detachably attached to the tray.

For example, Japanese Patent Application Publication No. 2010-244018 discloses an image forming apparatus which includes a tray to which a cartridge is detachably attached, and which is configured to be drawn out from both one end and the other end of the image forming apparatus.

Further, Japanese Patent Application Publication No. 2015-206897 discloses an image forming apparatus which includes a tray to which a cartridge is detachably attached, a transfer unit, and a fixing apparatus that is disposed on one end of the image forming apparatus. In this configuration, the tray is configured to be drawn out from one end of the image forming apparatus, and the transfer unit is configured to be drawn out from the other end of the image forming apparatus.

### SUMMARY

The present disclosure includes features to further advance the prior art.

According to some embodiments, the image forming apparatus of the present disclosure is characterized by features including:
an apparatus main body including an opening;
a first unit attached to the apparatus main body and configured to be movable from the apparatus main body through the opening; and
a second unit attached to the apparatus main body and configured to be movable from the apparatus main body through the opening, the second unit including an engaged portion, and is configured to be movable from the apparatus main body together with the first unit, and also to be movable from the apparatus main body independently from the first unit; and
an engaging member engaged with the engaged portion in a case where the second unit is moved out from the apparatus main unit body, the engaging member including a first path and a second path branching from the first path, wherein
in a case where the second unit is moved out together with the first unit, the engaged portion passes the first path, and in a case where the second unit is moved out independently from the first unit, the engaged portion passes the second path.

According to the present disclosure, the prior art can be further advanced.

Further features of the present disclosure will become apparent from the following description of exemplary embodiments with reference to the attached drawings.

### BRIEF DESCRIPTION OF THE DRAWINGS

FIG. 1 is a diagram for describing a general configuration of a printer of Embodiment 1.

FIG. 2 is a diagram depicting the printer of Embodiment 1 in a state where a door is open.

FIG. 3 is a diagram depicting the printer of Embodiment 1 in a state where a fixing apparatus is at a retracting position.

FIG. 4 is a diagram depicting the printer of Embodiment 1 in a state where two units are moved out.

FIG. 5 is a diagram depicting the printer of Embodiment 1 in a state where only a transfer unit is moved out.

FIG. 6 is a diagram for describing movement of the transfer unit and the tray unit of Embodiment 1.

FIG. 7 is a diagram for describing movement of the transfer unit and the tray unit of Embodiment 1.

FIG. 8 is a perspective view for describing an engaging configuration of the two units of Embodiment 1.

FIG. 9 is a side view for describing the engaging configuration of the two units of Embodiment 1.

FIG. 10 is a perspective view for describing the engaging configuration of the two units of Embodiment 1.

FIG. 11 is a diagram for describing details of a main guide of Embodiment 1.

FIG. 12 is a diagram for describing a moving path of the transfer unit of Embodiment 1.

FIGS. 13A and 13B are diagrams for describing a moving path of the transfer unit of Embodiment 1.

FIG. 14 is a diagram for describing a moving path of the transfer unit of Embodiment 1.

FIG. 15 is a perspective view for describing a regulating structure of Embodiment 1.

FIGS. 16A to 16C are diagrams for describing the regulating structure of Embodiment 1.

FIG. 17 is a diagram for describing the regulating structure of Embodiment 1.

FIGS. 18A to 18D are diagrams for describing a tray unit of a modification.

FIG. 19 is a diagram for describing a general configuration of a printer of Embodiment 2.

FIG. 20 is a diagram depicting the printer of Embodiment 2 in a state where the transfer unit is moved out.

FIG. 21 is a diagram depicting the printer of Embodiment 2 in a state where two units are moved out.

FIG. 22 is a diagram for describing a general configuration of a printer of Embodiment 3.

FIG. 23 is a diagram depicting the printer of Embodiment 3 in a state where the transfer unit is moved out.

FIG. 24 is a diagram depicting the printer of Embodiment 3 in a state where two units are moved out.

FIG. 25 is a diagram for describing details of a main guide of Embodiment 3.

FIG. 26 is a diagram for describing a moving path of the transfer unit of Embodiment 3.

FIG. 27 is a diagram for describing a moving path of the transfer unit of Embodiment 3.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

### Embodiment 1

### Configuration of Image Forming Apparatus

An image forming apparatus according to the present disclosure will be described first. Here the image forming apparatus is an apparatus that forms an image on a recording medium using various known image forming principles and methods, such as an electrophotographic process, an electrostatic recording process, and a magnetic recording process. For example, the image forming apparatus includes a copier, a printer (e.g. laser printer, LED printer), a facsimile device, a word processor and an image display device (e.g. electronic blackboard, electronic whiteboard). The recording medium is a medium on which an image is formed by the image forming apparatus, and includes paper, an overhead transparency (OHT) sheet and an image display body, for example.

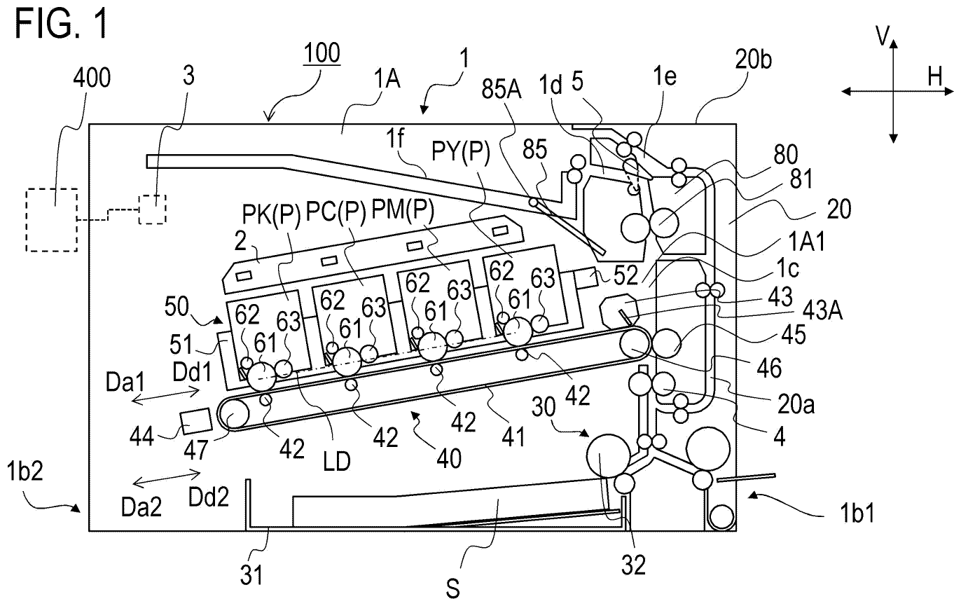

A printer 1 serving as an image forming apparatus according to Embodiment 1 will be described with reference to FIG. 1. FIG. 1 is a schematic cross-sectional view depicting a general configuration of the printer 1. The printer 1 is an electrophotographic type color laser beam printer, which forms an image on a sheet S (recording material).

The printer 1 includes an apparatus main body (casing) 1A, a scanner (exposing apparatus) 2, a control portion 3, and a door (open/close member) 20 which can be opened from/closed to the apparatus main body 1A. Further, the printer 1 includes a sheet feeding portion 30, a transfer unit (transfer apparatus) 40, a tray unit (moving unit, support unit) 50, and a fixing apparatus 80. A portion, which includes the apparatus main body 1A and the door 20, is called a main frame 100. The main frame 100 includes an exterior of the printer 1.

In the following description, a front side (front face side) of the printer 1 is the side where the door 20 is disposed. A rear side (rear face side) is the opposite side of the front side (front face side). A front-back direction is a direction from the rear side to the front side of the printer 1 (front direction), and an opposite direction thereof (rear direction). The left and right are the left and right when the printer 1 is viewed from the front side. A left-right direction is a direction from the right to left (left direction), and an opposite direction thereof (right direction). The top and bottom are the top and bottom in the gravity direction (vertical direction). An upward direction is a direction from the bottom to the top, and a downward direction is a direction from the top to the bottom. FIG. 1 is a diagram when the printer 1 is viewed in the left-right direction, and the front-back direction is indicated by H, and the top-bottom direction is indicated by V.

The apparatus main body 1A houses the scanner 2, the control portion 3, the sheet feeding portion 30, the tray unit 50 (first unit), the transfer unit 40 (second unit), and the fixing apparatus 80. The tray unit 50 and the transfer unit 40 are attached to the apparatus main body 1A, so as to be movable or drawable from the apparatus main body 1A respectively.

The sheet feeding portion 30 is a feeding portion which includes a loading tray 31 on which the sheets S (recording materials) are loaded, and a supply roller 32. The loading tray 31 is a feeding cassette which is configured to be inserted into/extracted from the apparatus main body 1A in the front-back direction. A user of the printer 1 can draw out the loading tray 31 from the apparatus main body 1A to the front side, and refill the sheets S. In other words, the user can insert/extract the loading tray 31 or open/close the door 20 from the front side of the apparatus main body 1A.

The tray unit 50 includes cartridges PY, PM, PC and PK, and a tray 51 which detachably holds each cartridge. The tray 51 has a tray handle 52. The tray handle 52 is disposed at the end portion of the tray 51 on the front side, so that the user can hold the tray handle 52 and draw the tray unit 50 out of the apparatus main body 1A. Each of the cartridges PY, PM, PC and PK is detachably attached to the tray 51 respectively. In other words, the tray unit 50 is constituted of a plurality of cartridges P and the tray 51 to which the plurality of cartridges P are detachably attached.

Each of the cartridges PY, PM, PC and PK can be detachably attached to the tray 51 independently from each other. The cartridge PY contains yellow (Y) toner (developer), the cartridge PM contains magenta (M) toner, the cartridge PC contains cyan (C) toner, and the cartridge PK contains black (K) toner. The cartridges PY, PM, PC and PK have the same configuration except for the color of the toner to be contained. Therefore, in the following description, the configuration and operation may be described for only one of the cartridges, PK, PM, PC and PY, and description on the other cartridges may be omitted. The cartridges PY, PM, PC and PK may simply be called the cartridge P, unless a distinction among the cartridges PY, PM, PC and PK is desired.

In Embodiment 1, the tray unit 50 is an image forming unit which includes a plurality of photosensitive drums (image bearing members) 61, a plurality of charging rollers (charging members) 62, and a plurality of developing rollers (developer bearing members) 63. Specifically, the tray unit 50 includes four photosensitive drums 61, four charging rollers 62, and four developing rollers 63. A rotation shaft direction of the photosensitive drum 61, a rotation shaft direction of the developing roller 63, and a rotation shaft direction of the charging roller 62 are parallel with the left-right direction of the printer 1.

A portion to form a black (K) image is called a black station (first station), and in the first station, the photosensitive drum 61 is called a first photosensitive drum, the developing roller 63 is called a first developing roller, and the charging roller 62 is called a first charging roller.

A portion to form a cyan (C) image is called a cyan station (second statin), and in the second station, the photosensitive drum 61 is called a second photosensitive drum, the developing roller 63 is called a second developing roller, and the charging roller 62 is called a second charging roller.

A portion to form a magenta (M) image is called a magenta station (third station), and in the third station, the photosensitive drum 61 is called a third photosensitive drum, the developing roller 63 is called a third developing roller, and the charging roller 62 is called a third charging roller.

A portion to form a yellow (Y) image is called a yellow station (fourth station), and in the fourth station, the photosensitive drum 61 is called a fourth photosensitive drum, the developing roller 63 is called a fourth developing roller, and the charging roller 62 is called a fourth charging roller.

The cartridge PK is attached to the black station, the cartridge PC is attached to the cyan station, the cartridge PM is attached to the magenta station, and the cartridge PY is attached to the yellow station respectively. In Embodiment 1, the cartridge PK is called a first cartridge, the cartridge PC is called a second cartridge, the cartridge PM is called a third cartridge, and the cartridge PY is called a fourth cartridge. Such numbers as the first, second, third and fourth are used for the sake of convenience in explanation.

In Embodiment 1, the cartridge P includes the photosensitive drum 61, the charging roller 62, and the developing roller 63. The photosensitive drum 61, the charging roller 62, and the developing roller 63 may be disposed on the tray 51, instead of the cartridge P.

The transfer unit 40 is a belt unit which includes a belt 41, a primary transfer roller 42, a cleaning portion 43, a driving roller 46 which drives the belt 41, and a tension roller (driven roller) 47. In the printer 1 according to Embodiment 1, an optical sensor 44, which detects a toner image transferred onto the belt 41, is disposed. In Embodiment 1, the belt 41 is disposed below the photosensitive drum 61. The belt 41 can contact the photosensitive drum 61, so that a primary transfer portion (transfer nip) is formed between the belt 41 and the photosensitive drum 61. The printer 1 also includes a secondary transfer roller 45 which contacts the belt 41 and forms a secondary transfer portion (transfer nip) with the belt 41. A rotation shaft direction of the primary transfer roller 42, a rotation shaft direction of the driving roller 46, a rotation shaft direction of the tension roller 47, and a rotation shaft direction of the secondary transfer roller 45 are parallel with the left-right direction of the printer 1. In the direction of conveying the sheet S, a registration roller pair 4 is disposed on the front side (upstream side) of the secondary transfer portion.

The fixing apparatus 80 includes a fixing portion 81 and a flapper 5. When an image forming operation is performed on the sheet S, the fixing apparatus 80 is at a fixing position. The fixing apparatus 80 at the fixing position is housed inside (inner side) of the apparatus main body 1A, so that the sheet S can be heated. The fixing apparatus 80 is configured to be movable between the fixing position and a retracting position where the operation to draw out the tray unit 50 is not interfered with. In Embodiment 1, the fixing portion 81 includes a heating portion (heat roller) which includes a heater and a pressing portion (pressure roller).

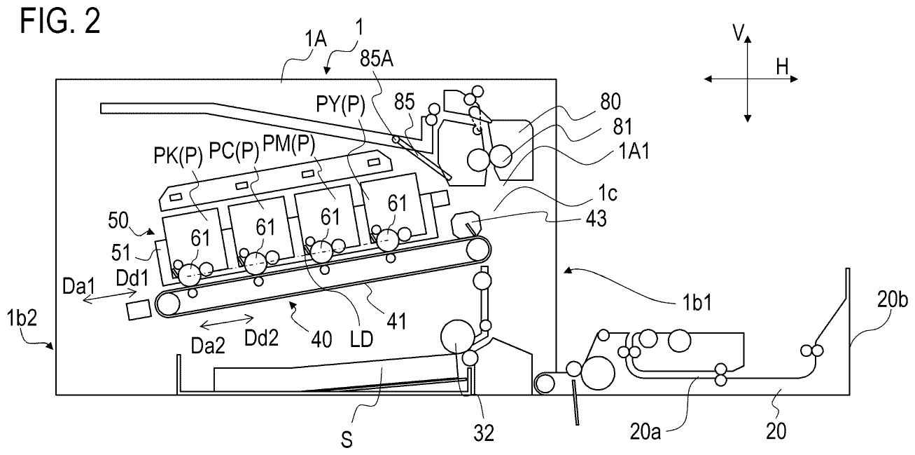

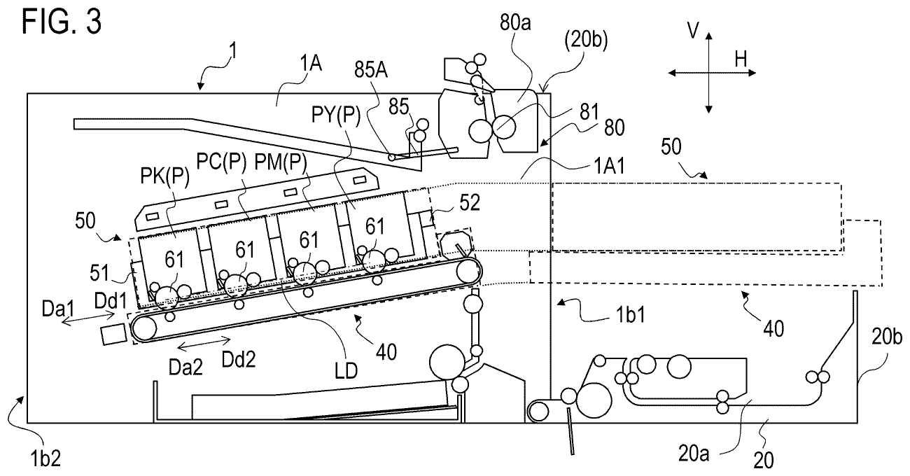

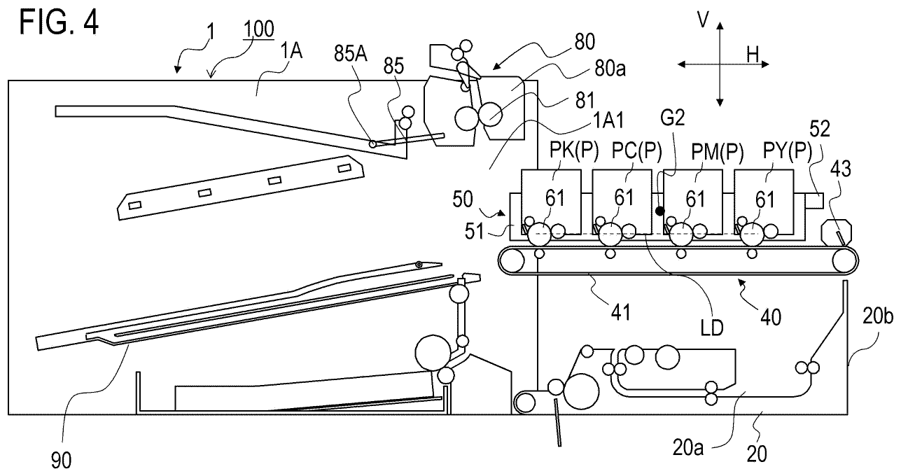

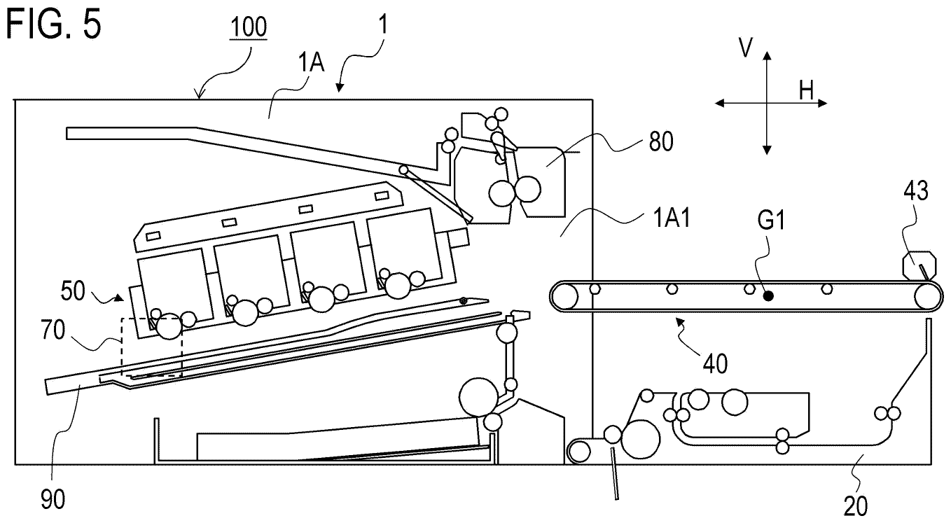

The moving operation of the transfer unit 40 and the tray unit 50 will be described with reference to FIGS. 1, 2, 3, 4 and 5. FIG. 2 is a diagram depicting the printer 1 in a state where the door 20 is open. FIG. 3 is a diagram depicting the printer 1 in a state where the fixing apparatus 80 is at the retracting position. FIG. 4 is a diagram depicting the printer 1 in a state where the transfer unit 40 and the tray unit 50 are moved out of the apparatus main body 1A. FIG. 5 is a diagram depicting the printer 1 in a state where the transfer unit 40 alone is moved out of the apparatus main body 1A. FIGS. 2, 3, 4 and 5 are all schematic diagrams viewing the printer 1 in the left-right direction.

The transfer unit 40 and the tray unit 50 are each attached, through an opening 1A1 of the apparatus main body 1A, to the apparatus main body 1A, so as to be movable or drawable from the apparatus main body 1A. In other words, the transfer unit 40 and the tray unit 50 are configured to be movable from the inside to outside the apparatus main body 1A. In the front-back direction H, the apparatus main body 1A has a first end portion 1b1 on the front side where the opening 1A1 is disposed, and a second end portion 1b2 on the rear side which is the opposite side of the first end portion 1b1. The tray unit 50 is movable, through the opening 1A1, between a first inner position (inner side of the apparatus main body 1A) and a first outer position (outer side of the apparatus main body 1A). The transfer unit 40 is movable, through the opening 1A1, between a second inner position (inner side of the apparatus main body 1A) and a second outer position (outer side of the apparatus main body 1A). In Embodiment 1, a common opening 1A1 is disposed for the tray unit 50 and the transfer unit 40 to move, but an opening for the tray unit 50 to move and an opening for the transfer unit 40 to move may be individually disposed in the apparatus main body 1A. Here “the unit (transfer unit 40 or tray unit 50) is located outside the apparatus main body 1A” means that at least a part of the unit is located outside the apparatus main body 1A, and may not necessarily be that the entire unit is located outside the apparatus main body 1A. In Embodiment 1, in a state where the transfer unit 40 is located at the second outer position, at least a part of the belt 41 protrudes to the front side from the apparatus main body 1A through the opening 1A1.

The direction of moving the tray unit 50 from the first inner position to the first outer position is called a first detaching direction Dd1, and the opposite direction of the first detaching direction Dd1 is called a first attaching direction Da1. The first detaching direction Dd1 is a direction from the second end portion 1b2 (rear side) to the first end portion 1b1 (front side).

In the state where the tray unit 50 is attached to the apparatus main body 1A, a direction parallel with the left-right direction of the printer 1 is assumed to be the width direction of the tray unit 50. An extending direction of the tray 51, intersecting with the width direction of the tray unit 50, is assumed to be a longitudinal direction of the tray unit 50. In Embodiment 1, in the state where the tray unit 50 is attached to the apparatus main body 1A at the first inner position, the longitudinal direction of the tray unit 50 intersects with the front-back direction H.

The direction of moving the transfer unit 40 from the second inner position to the second outer position is called a second detaching direction Dd2, and the opposite direction of the second detaching direction Dd2 is called a second attaching direction Da2. In the second detaching direction Dd2, the driving roller 46 is disposed on the downstream side of the tension roller 47. The second detaching direction Dd2 is a direction from the second end portion 1b2 (rear side) to the first end portion 1b1 (front side).

In the state where the transfer unit 40 is attached to the apparatus main body 1A, a direction parallel with the left-right direction of the printer 1 is assumed to be the width direction of the transfer unit 40. A direction, which intersects with the width direction of the transfer unit 40 and which is parallel with a line connecting the rotation center of the driving roller 46 and the rotation center of the tension roller 47, is assumed to be the longitudinal direction of the transfer unit 40. In Embodiment 1, in the state where the transfer unit 40 is attached to the apparatus main body 1A at the second inner position, the longitudinal direction of the transfer unit 40 intersects with the front-back direction H.

The first detaching direction Dd1 and the first attaching direction Da1 are directions intersecting with (can be orthogonal to) the rotation shaft direction of the photosensitive drum 61. The second detaching direction Dd2 and the second attaching direction Da2 are directions intersecting with (can be orthogonal to) the rotation shaft direction of the driving roller 46. The rotation shaft direction of the driving roller 46 is parallel with the rotation shaft direction of the photosensitive drum 61.

In the front-back direction H, the fixing apparatus 80 is disposed on the first end portion 1b1 side of the apparatus main body 1A. The fixing apparatus 80 is located on the first end portion 1b1 side with respect to the tray unit 50, which is located at the first inner position.

The door 20, installed in the apparatus main body 1A, is movable between a closed position and an open position. As illustrated in FIG. 1, in a state where the door 20 is at the closed position (state where the door 20 is closed), the door 20 covers the opening 1A1. As illustrated in FIG. 2, in a state where the door 20 is at the open position (state where the door 20 is open), the opening 1A1 is exposed.

As illustrated in FIG. 1, in the state where the door 20 is at the closed position, the door 20 covers the fixing apparatus 80, which is installed in the apparatus main body 1A. Specifically, in the state where the door 20 is at the closed position, an upper cover portion 20b of the door 20 is located above the fixing apparatus 80, and covers the fixing apparatus 80 from the top. The upper cover portion 20b of the door 20 functions as a part of the exterior of the printer 1.

In a state where the fixing apparatus 80 is supported by the apparatus main body 1A, the door 20 can move between the open position and the closed position. In other words, the door 20 moves from the closed position to the open position so as to move separate from the fixing apparatus 80 supported by the apparatus main body 1A. Therefore, as illustrated in FIG. 2, in a state where the door 20 is at the open position, the door 20 is separate from the fixing apparatus 80 supported by the apparatus main body 1A.

The fixing apparatus 80 can move from the fixing position illustrated in FIG. 2 to the retracting position illustrated in FIG. 3, so that the opening 1A1 is more widely exposed. The moving mechanism of the fixing apparatus 80 will be described in detail later. In the state where the door 20 is located at the open position, and the fixing apparatus 80 is located at the retracting position (state in FIG. 3), the transfer unit 40 and the tray unit 50 can move from the inside to the outside of the apparatus main body 1A through the opening 1A1. FIG. 4 illustrates the state where the transfer unit 40 and the tray unit 50 have moved outside moved out of the apparatus main body 1A.

In the state where the tray unit 50 is moved out of the apparatus main body 1A (state in FIG. 4), the cartridges PY, PM, PC and PK can be detached from the tray 51, or the cartridges PY, PM, PC and PK can be attached to the tray 51. Thereby the cartridges PY, PM, PC and PK can be replaced with new cartridges PY, PM, PC and PK. In Embodiment 1, the cartridges P can be detachably attached to the tray 51 in the direction intersecting with (can be orthogonal to) the rotation shaft line of the photosensitive drum 61.

The cartridges PY, PM, PC and PK can be detached from the tray 51 by being moved from the tray 51 in a direction separate from the transfer unit 40. In other words, the cartridges PY, PM, PC and PK can be detached from the tray 51 by being moved from the tray 51 in a direction opposite the transfer unit 40 side. In Embodiment 1, the transfer unit 40 is disposed below the tray unit 50. Therefore, the cartridges PY, PM, PC and PK are detached from the tray 51 by being moved upward from the tray 51.

The transfer unit 40 is configured to be movable or drawable from the apparatus main body 1A together with the tray unit 50, or be movable or drawable from the apparatus main body 1A independently from the tray unit 50. In other words, the user of the printer 1 can select whether the transfer unit 40 alone is moved or drawn out or the transfer unit 40 is moved or drawn out together with the tray unit 50. The method for drawing out the transfer unit 40 and the tray unit 50 will be described in detail later.

### Image Forming Operation

An image forming operation of the printer 1 will be described with reference to FIG. 1. The control portion 3 of the printer 1 starts the image forming operation on a sheet S based on an image signal received from an external host apparatus 400. The external host apparatus 400 is, for example, a personal computer, an image reader, a facsimile or the like.

When an image is formed on a sheet S, the fixing apparatus 80 is located at the fixing position, the tray unit 50 is located at the first inner position, the transfer unit 40 is located at the second inner position, and the door 20 is located at the closed position. In a state where the transfer unit 40 is at the second inner position, the belt 41 can contact the photosensitive drum 61. A contacting/separating mechanism, to allow the photosensitive drum 61 to contact with/separate from the belt 41, may be installed. Here the tray unit 50 is located above the transfer unit 40.

During the image forming operation, charging voltage is applied to the charging roller 62, and the photosensitive drum 61 rotates. Then laser, corresponding to the image information, is emitted from the scanner 2 to the photosensitive drum 61, whereby the surface of the photosensitive drum 61, charged by the charging roller 62, is exposed. As a result, an electrostatic latent image, corresponding to the image information, is formed on the surface of the photosensitive drum 61.

The developing roller 63 bears toner. Developing voltage is applied to the developing roller 63, and the electrostatic latent image formed on the photosensitive drum 61 is developed by the toner supplied from the developing roller 63, whereby a toner image is formed on the surface of the photosensitive drum 61. In Embodiment 1, the electrostatic latent image is developed in the state where the developing roller 63 is in contact with the photosensitive drum 61, but the developing roller 63 may develop the electrostatic latent image in a state where there is a gap between the developing roller 63 and the photosensitive drum 61.

In a case of forming a full color image on a sheet S, a toner image of each color, from the respective cartridge P, is formed on the photosensitive drum 61.

In Embodiment 1, in the state where the tray unit 50 is at the first inner position, the developing roller 63 can move between the contacted positions, which contacts with the photosensitive drum 61 and the separated position which is separated from the photosensitive drum 61. Specifically, the state where the developing roller 63 is at the contacted position and the state where the developing roller 63 is at the separated position are switched by a switching device included in the apparatus main body 1A. Thereby the developing roller 63 can be separated from the photosensitive drum 61 in a state where the image forming operation is not performed.

The printer 1 can perform monochrome printing in a state where the developing roller 63 and the photosensitive drum 61, corresponding to the cartridge PK, are in contact, and the developing rollers 63 and the photosensitive drums 61, corresponding to the cartridge PY, PM and PC respectively, are separated. The printer 1 can perform full color printing in a state where the photosensitive drums 61, corresponding to the cartridges PY, PM, PC, and PK, are in contact with the belt 41.

The toner images formed on the respective photosensitive drums 61 are transferred onto the belt 41 in the primary transfer portion, and are conveyed toward the secondary transfer portion formed by the belt 41 and the secondary transfer roller 45.

In the apparatus main body 1A, a conveying path (first path, first conveying path) 1c is formed, on which a sheet S passes toward the fixing apparatus 80. The sheet S is conveyed from the sheet feeding portion 30 to the fixing apparatus 80 by a conveying portion constituted of a plurality of rollers and the like, so as to pass through the conveying path 1c. On the door 20, a double-sided conveying path (second path, second conveying path) 20a is formed, where the sheet S, which passed the fixing apparatus 80, passes. The door 20 covers the conveying path 1c in the closed state. The door 20 also functions as a conveying path forming portion, which forms the conveying path 1c, along with the apparatus main body 1A. By opening the door 20, the conveying path 1c and the double-sided conveying path 20a are exposed, as illustrated in FIG. 2.

In the sheet feeding portion 30, one sheet S is separated and fed from the loading tray 31, where the sheets S are loaded, by a supply roller 32 at a predetermined timing, and the sheet S is conveyed toward the secondary transfer portion and the fixing apparatus 80 via the conveying path 1c. Then the toner image, formed on the belt 41, and the sheet S, reach the secondary transfer portion at the same timing.

In the secondary transfer portion, the toner image is transferred from the belt 41 onto the sheet S. The toner, which was not transferred to the sheet S, is removed from the belt 41 by a cleaning blade (cleaning member) 43A disposed in the cleaning portion 43. The cleaning portion 43 is disposed at the downstream side of the secondary transfer portion, which is at the upstream side of the primary transfer portion, in the direction where the belt 41 rotates during the image forming operation. The rotation direction of the belt 41 during the image forming operation is the counterclockwise direction in FIG. 1.

The sheet S, on which the toner image was transferred in the secondary transfer portion, is conveyed toward the fixing apparatus 80. In the fixing apparatus 80, the sheet S is heated and pressed in the fixing portion 81, whereby the toner image is fixed to the sheet S. The sheet S, on which the toner image was fixed, is conveyed to the flapper (path switching portion) 5.

The flapper 5 can move between: a paper delivery position at which the sheet S, which passed through the fixing apparatus 80, is guided toward the paper delivery path 1d; and an inversion position at which the sheet S is guided toward an inversion path 1e.

In a case of single-sided printing (image is printed on one side of the sheet S), the sheet S is guided to the paper delivery path 1d by the flapper 5, and is delivered to a delivery tray 1f formed in an upper portion of the apparatus main body 1A.

In a case of double-sided printing (images are printed on both (front face and rear face of the sheet S), the sheet S is guided to the inversion path 1e by the flapper 5. After the sheet S is guided to the inversion path 1e, the conveying direction of the sheet S is inverted, and the sheet S is conveyed toward the secondary transfer portion via the double-sided conveying path 20a, which is formed on the door 20. In the secondary transfer portion, the toner image is transferred onto the rear face of the sheet S, then the sheet S passes through the fixing apparatus 80 and is guided to the delivery path 1d by the flapper 5, and is delivered to the delivery tray 1f of the apparatus main body 1A.

### Arrangement Configuration of Various Units

An arrangement configuration of various units (tray unit 50, transfer unit 40, fixing apparatus 80, and the like) constituting the apparatus main body 1A will be described with reference to FIGS. 1, 2, 3, 4 and 5. In particular, the moving space (moving locus) of the tray unit 50 and the transfer unit 40, when being moved out of the apparatus main body 1A, and the position where the fixing apparatus 80 is disposed, will be described in detail.

The fixing apparatus 80 of the printer 1 is disposed on the first end portion 1b1 side of the apparatus main body 1A in the horizontal direction. The transfer unit 40 and the tray unit 50 move outside the apparatus main body 1A through the opening 1A1 disposed on the first end portion 1b1 side of the apparatus main body 1A.

In Embodiment 1, the fixing apparatus 80 is disposed at a position closer to the first end portion 1b1 than the second end portion 1b2 of the apparatus main body 1A. In other words, in the horizontal direction, the distance between the fixing apparatus 80 and the first end portion 1b1 is shorter than the distance between the fixing apparatus 80 and the second end portion 1b2. The fixing apparatus 80 is disposed at a position closer to the first end portion 1b1 than a mid-point of the apparatus main body 1A in the horizontal direction, that is, the distance between the first end portion 1b1 and the fixing apparatus 80 is shorter than the distance between the first end portion 1b1 and the mid-point of the apparatus main body 1A in the horizontal direction.

When the tray unit 50 moves from the first inner position to the first outer position, the moving direction of the tray unit 50 is a direction intersecting with the rotation shaft line of the photosensitive drum 61 (first detaching direction Dd1). Here the tray unit 50 moves separate from the second end portion 1b2.

In the same manner, when the transfer unit 40 moves from the second inner position to the second outer position, the moving direction of the transfer unit 40 is a direction intersecting with the rotation shaft line of the driving roller 46 (second detaching direction Dd2). Here the transfer unit 40 moves separate from the second end portion 1b2.

The door 20 disposed on the first end portion 1b1 side of the apparatus main body 1A covers the opening 1A1, and also covers at least a part of the conveying path 1c of the sheet S, in the closed state. The door 20 also includes the double-sided conveying path 20a. If the sheet S jams (hereafter called jam), the user of the printer 1 can remove the sheet S from the first end portion 1b1 side of the apparatus main body 1A, so as to clear the jam. Specifically, the user moves the door 20 to the open position, and accesses the conveying path 1c inside the apparatus main body 1A and the double-sided conveying path 20a of the door 20, whereby the sheet S can be removed. Further, in a case where a part of the sheet S, which passed through the fixing apparatus 80, is exposed outside the apparatus main body 1A, the user can remove the sheet S by pulling the sheet S from outside the apparatus main body 1A without opening the door 20.

Furthermore, the user of the printer 1 can draw the transfer unit 40 and the tray unit 50 out of the apparatus main body 1A from the first end portion 1b1 side of the apparatus main body 1A, so as to move the units to outside the apparatus main body 1A. In the same manner, the user can insert the transfer unit 40 and the tray unit 50 into the apparatus main body 1A from the first end portion 1b1 side of the apparatus main body 1A, so as to move the units to inside the apparatus main body 1A. In other words, the user can check the states of the transfer unit 40 and the cartridge P and perform such an operation as maintenance and replacement, from the first end portion 1b1 side of the apparatus main body 1A.

Moreover, the loading tray 31, on which sheets S are loaded, is configured to be movable or drawable from the first end portion 1b1 side of the apparatus main body 1A. Therefore, the user of the printer 1 can refill the sheets S from the first end portion 1b1 side of the apparatus main body 1A.

As mentioned above, in the printer 1, the fixing apparatus 80 and the door 20 are disposed on the first end portion 1b1 side of the apparatus main body 1A. The transfer unit 40 and the tray unit 50 are configured to be movable between the inside and outside the apparatus main body 1A through the opening 1A1 on the first end portion 1b1 side of the apparatus main body 1A, and the loading tray 31 can also be moved from the first end portion 1b1 side of the apparatus main body 1A. By this configuration, the user can clear a jam, access the fixing apparatus 80, attach/detach the transfer unit 40 and the tray unit 50, and refill the sheets S from the same direction (front side in Embodiment 1).

In Embodiment 1, the front face of the printer 1 is on the first end portion 1b1 side where the door 20 is disposed. Therefore, the printer 1 can be installed only if there is space to perform clearing a jam, operation of the transfer unit 40 and the tray unit 50 and the like, from the front face of the printer 1. There is no space needed to perform these operations on the left face, right face, rear face and top face of the printer 1. In other words, according to the configuration of Embodiment 1, space to install the printer 1 can be reduced.

If the transfer unit 40 or the tray unit 50 is moved out from the second end portion 1b2 side of the apparatus main body 1A, the user must access the apparatus main body 1A from both end sides to clear a jam and draw out the transfer unit 40 and the tray unit 50. In a case where one of the transfer unit 40 and the tray unit 50 is moved out from one end side of the apparatus main body 1A, and the other of the transfer unit 40 and the tray unit 50 is moved out from the other end side of the apparatus main body 1A as well, the user must access the apparatus main body 1A from both end sides. Therefore, work space can be used not only on the front face side but also on the rear face side of the apparatus main body 1A, and the area that can be used for installing the printer 1 increases.

### Positional Relationship of Tray Unit and Fixing Apparatus

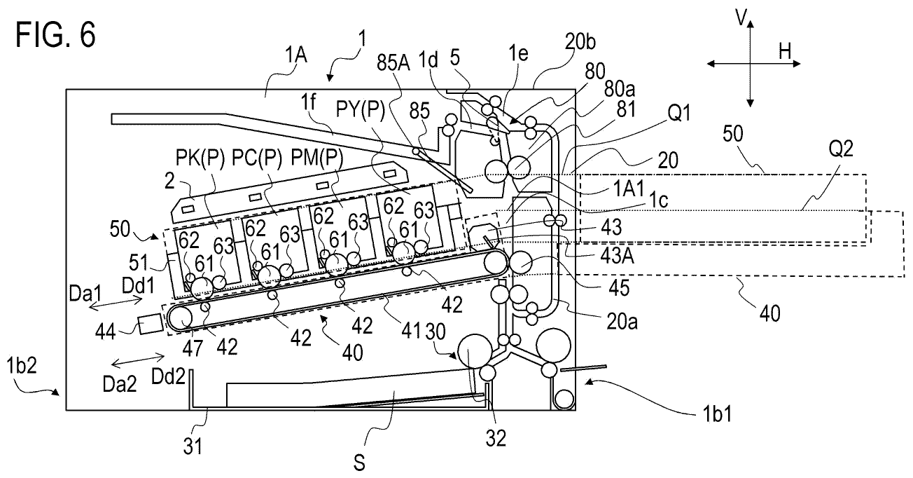

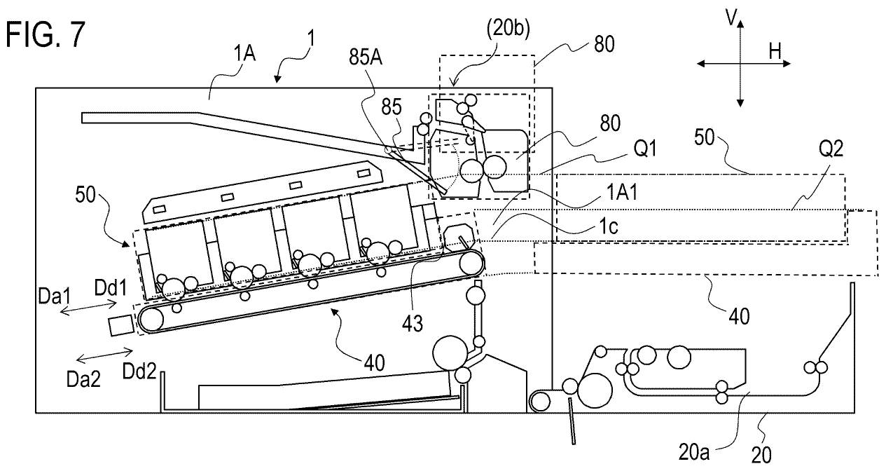

The positional relationship of the tray unit 50 and the fixing apparatus 80 will be described with reference to FIGS. 1, 2, 3, 4, 6 and 7. FIGS. 6 and 7 are diagrams for describing movement of the transfer unit 40 and the tray unit 50, and are schematic cross-sectional views when the printer 1 is viewed in the left-right direction. FIG. 6 illustrates the printer 1 in the state where the door 20 is closed, and FIG. 7 illustrates the printer 1 in the state where the door 20 is open.

The tray unit 50 passes through a predetermined space to move to the first inner position where the image forming operation is performed on a sheet S, or to the first outer position where the replacement of the cartridge P is allowable. Hereafter this space, where the tray unit 50 moves from the first inner position to the first outer position (moving space of the tray unit 50), is called a first space Q1. The first space Q1 can be regarded as a path or locus (first moving path, first moving locus) that the tray unit 50 passes to move from the first inner position to the first outer position. In FIGS. 6 and 7, approximate outlines of the tray unit 50 of the first outer position and the first inner position are indicated by broken lines respectively, and the first space Q1 is indicated by a dotted lines.

The transfer unit 40 passes through a predetermined space to move to the second inner position where the image forming operation is performed on a sheet S, or to the second outer position. Hereafter this space, where the transfer unit 40 moves from the second inner position to the second outer position (moving space of the transfer unit 40) is called a second space Q2. The second space Q2 can be regarded as a path or locus (second moving path, second moving locus) that the transfer unit 40 passes to move from the second inner position to the second outer position. In FIGS. 6 and 7, approximate outlines of the transfer unit 40 at the second outer position and the second inner position are indicated by broken lines respectively, and the second space Q2 is indicated by a dotted lines.

When the image forming operation is performed on the sheet S, the fixing apparatus 80 is located at the fixing position, as indicated in FIG. 6. The fixing apparatus 80, which is located at the fixing position, is on the first end portion 1b1 side of the tray unit 50, which is located at the first inner position, and a part of the fixing apparatus 80 overlaps with the first space Q1. In other words, in the state where the fixing apparatus 80 is at the fixing position, at least a part of the fixing apparatus 80 is within the first space Q1.

Further, in Embodiment 1, when the door 20 is closed, at least a part of the double-sided conveying path 20a disposed on the door 20 overlaps with the first space Q1, as illustrated in FIG. 6. In other words, when the door 20 is closed, at least a part of the double-sided conveying path 20a is within the first space Q1.

In the state where the fixing apparatus 80 is at the fixing position, if the tray unit 50 attempts to move from the first inner position to the first outer position, the tray unit 50 interferes with the fixing apparatus 80, and drawing out the tray unit 50 is restricted. Therefore, the fixing apparatus 80 is configured to be retractable from the fixing position. Specifically, the fixing apparatus 80 is configured to be movable between the fixing position and the retracting position, which is retracted from the fixing position. In FIG. 7, approximate outlines of the fixing apparatus 80 at the retracting position and the fixing position are indicated by broken lines respectively. When the fixing apparatus 80 is located at the retracting position, where the fixing apparatus 80 is retracted from the fixing position, the entire fixing apparatus 80 is located outside the first space Q1, and the tray unit 50 is allowed to move from the first inner position to the first outer position.

When the tray unit 50 moves from the first inner position to the first outer position, the tray unit 50 passes below the fixing apparatus 80, which is located at the retracting position. At the fixing position and the retracting position, the fixing apparatus 80 is located outside the second space Q2. Therefore, in both the state where the fixing apparatus 80 is at the fixing position and the state where the fixing apparatus 80 is at the retracting position, the transfer unit 40 can move from the second inner position to the second outer position. This means that in the case of drawing out only the transfer unit 40 from the apparatus main body 1A, there is no need to move the fixing apparatus 80. When the transfer unit 40 moves from the second inner position to the second outer position, the transfer unit 40 passes below the fixing apparatus 80.

By this configuration, the fixing apparatus 80 can be disposed in the apparatus main body 1A such that a part of the fixing apparatus 80, located at the fixing position, overlaps with the first space Q1, hence compared with the configuration where the entire fixing apparatus 80 is located outside the first space Q1, the size of the apparatus main body 1A can be reduced. In Embodiment 1, when the tray unit 50 moves from the first inner position to the first outer position, at least a part of the fixing apparatus 80 overlaps with the space where the cartridge P passes, but the fixing apparatus 80 may be disposed so as to overlap with the space where the tray 51 passes.

To draw the tray unit 50 out of the apparatus main body 1A, the door 20 is moved to the open position, as illustrated in FIG. 2. In Embodiment 1, the door 20 can be moved to the open position and the closed position in a state where the fixing apparatus 80 is located at the fixing position. Then in the state where the door 20 is at the open position, the fixing apparatus 80 can be moved from the fixing position to the retracting position such that the fixing apparatus 80 moves outside the first space Q1, as illustrated in FIG. 3.

Further, the fixing apparatus 80 moves to the retracting position above the fixing position by being lifted from the fixing position. In other words, the retracting position is a position higher than the fixing position. As illustrated in FIG. 7, when the fixing apparatus 80 is at the retracting position, at least a part of the fixing apparatus 80 is at a position protruding out from the apparatus main body 1A. Further, when the fixing apparatus 80 is at the retracting position, at least a part of the fixing apparatus 80 is located at a position higher than the position of the upper cover portion 20b of the door 20 in the closed position. Thereby the fixing apparatus 80 can move to the retracting position, while maintaining a small size of the printer 1 when the fixing apparatus 80 is at the fixing position, in the vertical direction V, and the space for the tray unit 50 to move can be secured. In the state where the fixing apparatus 80 is located at the retracting position outside the first space Q1, the user can hold the tray handle 52 and move the tray unit 50 toward outside the apparatus main body 1A. Furthermore, since the movement of the door 20 to the closed position is restricted when the fixing apparatus 80 is at the retracting position, the door 20 can be prevented from being closed while forgetting to return the fixing apparatus 80 to the fixing position.

Specifically, the moving mechanism of the fixing apparatus 80 according to Embodiment 1 will be described. The fixing apparatus 80 includes a fixing frame 80a which supports the fixing portion 81. When the fixing apparatus 80 is retracted from the fixing position, the fixing frame 80a is displaced with respect to the apparatus main body 1A in a state of supporting the fixing portion 81.

The fixing apparatus 80 according to Embodiment 1 can move between the fixing position and the retracting position in the state of being installed in the apparatus main body 1A. When the fixing apparatus 80 is at the retracting position, the entire fixing apparatus 80 is located outside the first space Q1.

The printer 1 includes a linking member (fixing linking member, fixing link, arm) 85, which is movably linked to the apparatus main body 1A. The fixing apparatus 80 is linked to the apparatus main body 1A via the linking member 85.

The linking member 85 is a rotating member which can rotate around a rotation center 85A. The linking member 85 rotate around a rotation shaft line which extends in the left-right direction of the printer 1. In the case where the tray unit 50 is moved out of the apparatus main body 1A, the linking member 85 is moved outside the first space Q1. The fixing apparatus 80 is connected to one end of the linking member 85, and the other end of the linking member 85 is connected to the apparatus main body 1A. The fixing apparatus 80 can be moved from the fixing position to the retracting position, or from the retracting position to the fixing position, in the state of being supported by the linking member 85 (in the state of being linked to the apparatus main body 1A via the linking member 85). The linking member 85 is rotatably linked to the fixing apparatus 80, and the fixing apparatus 80 can move to the retracting position in the state of maintaining the attitude at the fixing position. By this configuration of connecting the fixing apparatus 80 to the apparatus main body 1A via the linking member 85, the moving distance of the fixing apparatus 80, when the fixing apparatus 80 moves between the retracting position and the fixing position, can be increased.

As illustrated in FIG. 7, when the tray unit 50 moves from the first inner position to the first outer position, the angle formed by the moving direction of the tray unit 50 and the horizontal direction is smaller than an angle formed by the moving direction of the tray unit 50 and the vertical direction V. Further, when the fixing apparatus 80 moves from the fixing position to the retracting position, the moving distance of the fixing apparatus 80 in the vertical direction V is larger than the moving distance of the fixing apparatus 80 in the horizontal direction. In other words, when the fixing apparatus 80 moves from the fixing position to the retracting position, the moving distance of the fixing apparatus 80 in a direction that is approximately orthogonal to the moving direction of the tray unit 50 is larger than the moving distance of the fixing apparatus 80 in a direction parallel with the moving direction of the tray unit 50.

The fixing apparatus 80 may be configured to move to the fixing position and the retracting position in the state of being installed in the apparatus main body 1A via a guide, which is fixed to the apparatus main body 1A. The method for moving the fixing apparatus 80 outside the first space Q1 is not limited to this. For example, the fixing apparatus 80 may be configured to be detachable from the apparatus main body 1A so that the fixing apparatus 80 is retracted from the fixing position, and thereby the fixing apparatus 80 may be moved outside the first space Q1. In other words, the fixing apparatus 80 may be moved to a position outside the first space Q1 by separating the fixing apparatus 80 from the apparatus main body 1A and the door 20 (separating from the main frame 100). Further, the fixing apparatus 80 may be linked to the door 20 so that the fixing apparatus 80 is moved outside the first space Q1 by opening the door 20.

### Positional Relationship of Tray Unit and Transfer Unit

The positional relationship of the tray unit 50 and the transfer unit 40 will be described with reference to FIGS. 1, 2, 3, 4, 5, 6 and 7.

When the image forming operation is performed on the sheet S, the transfer unit 40 is located at the second inner position. A part of the transfer unit 40 is inside the first space Q1, as illustrated in FIGS. 6 and 7. Specifically, the cleaning portion 43, which is a part of the transfer unit 40, is located inside the space where the tray 51 passes when the tray unit 50 moves from the first inner position to the first outer position. Thereby compared with the configuration where the entire transfer unit 40, located at the second inner position, is disposed outside the first space Q1, the size of the apparatus main body 1A can be reduced. In Embodiment 1, the cleaning portion 43 overlaps with the space where the tray 51 passes through, but may overlap with the space where the cartridge P passes through. Further, a portion other than the cleaning portion 43 of the transfer unit 40 may overlap with the first space Q1. In Embodiment 1, the cleaning member 43A of the transfer unit 40, located at the second inner position, overlaps with the first space Q1.

In Embodiment 1, in the state where the tray unit 50 is at the first inner position and the transfer unit 40 is at the second inner position, the cleaning portion 43 is located on the downstream side of the tray unit 50 in the first detaching direction Dd1. Further, in the vertical direction V, the region (range) where the cleaning portion 43 is disposed and the region (range) where the tray unit 50 is disposed overlap with each other at least partially. When the tray unit 50 is moved out of the apparatus main body 1A, the transfer unit 40 is moved out simultaneously, hence there is no concern that the cleaning portion 43 will interrupt the drawing out operation of the tray unit 50. Further, because the tray unit 50 and the transfer unit 40 move together, the photosensitive drum 61 can be prevented from being exposed when the tray unit 50 moves to the first outer position, and scratches and contamination of the photosensitive drum 61 can be prevented thereby.

In Embodiment 1, the conveying path 1c overlaps with the first space Q1 and the second space Q2. In other words, the sheet S is conveyed from the sheet feeding portion 30 to the fixing apparatus 80 through the first space Q1 and the second space Q2. Further, when the door 20 is closed, at least a part of the double-sided conveying path 20a overlap with the second space Q2, where the transfer unit 40 passes to move from the second inner position to the second outer position. This means that when the door 20 is closed, at least a part of the double-sided conveying path 20a is located within the second space Q2.

In a state where the door 20 is at the open position, the tray unit 50 is at the first outer position and the transfer unit 40 is at the second outer position, as illustrated in FIG. 4, the transfer unit 40 supports the tray unit 50 from the bottom of the tray unit 50. Further, in Embodiment 1, the door 20 supports the transfer unit 40. In other words, the transfer unit 40, supported by the door 20, supports the tray unit 50. This state can be regarded as a state where the door 20 supports the tray unit 50 via the transfer unit 40.

### Engagement Configuration of Tray Unit and Transfer Unit

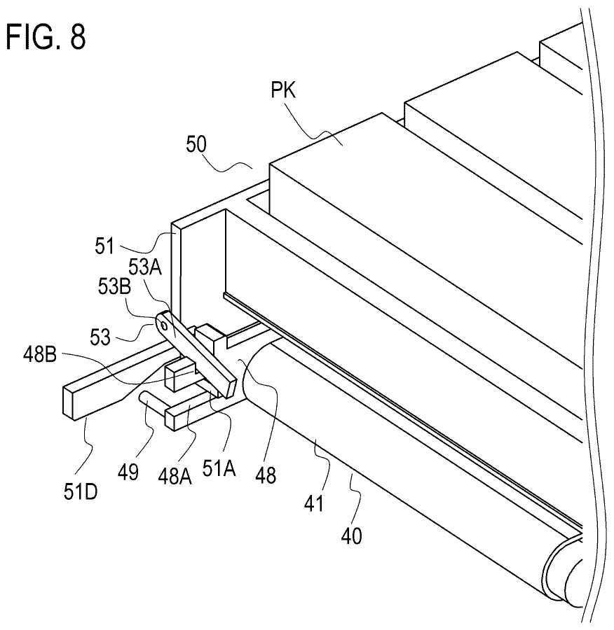

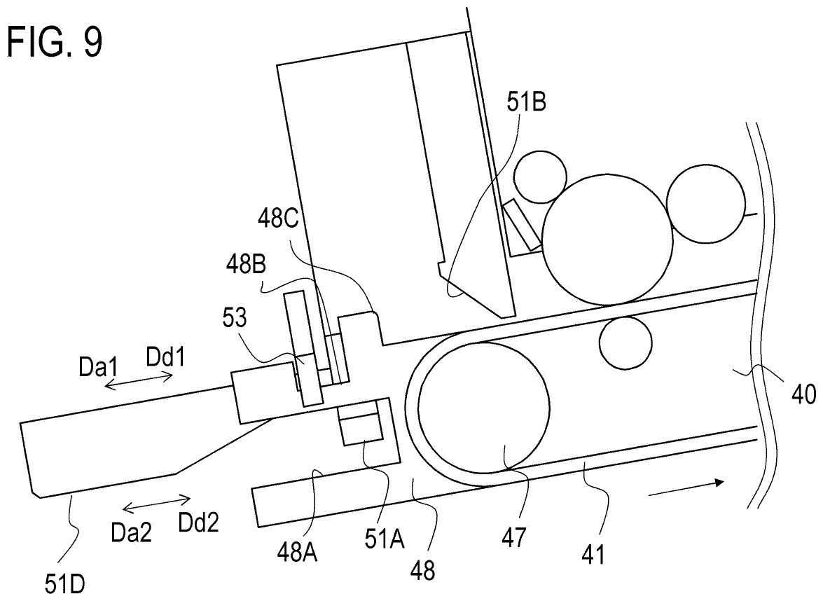

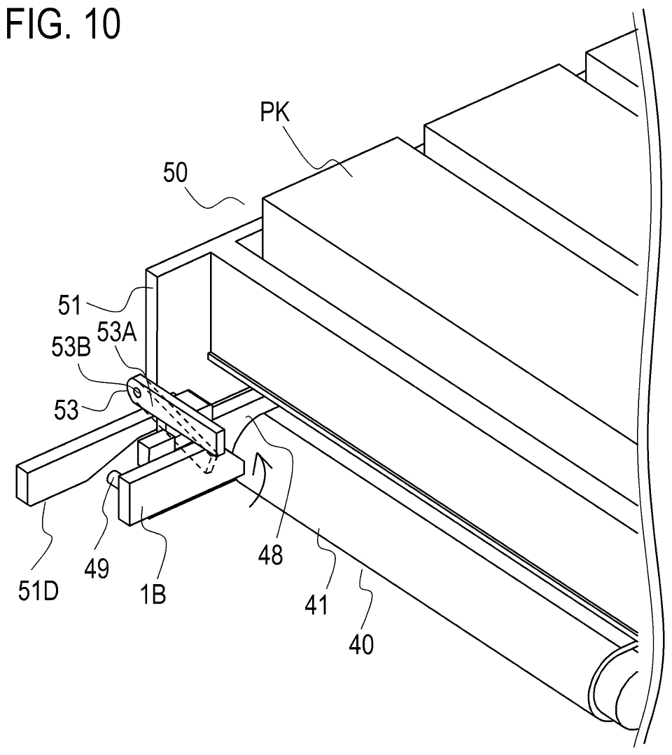

An engagement configuration of the tray unit 50 and the transfer unit 40 will be described with reference to FIGS. 8, 9 and 10. FIGS. 8, 9 and 10 are diagrams for describing the engagement configuration for the tray unit 50 and the transfer unit 40 to be engaged with each other. FIGS. 8 and 10 are perspective views depicting one end in the longitudinal direction and one end in the width direction of the tray unit 50 and the transfer unit 40. FIG. 9 is a diagram depicting one end portion (vicinity of the tension roller 47) of the tray unit 50 and the transfer unit 40 in the longitudinal direction, and is a side view of the tray unit 50 (transfer unit 40) viewed from the width direction.

The tray unit 50 includes a lock member (linking member, lever, stopper) 53 disposed in the tray 51. The lock member 53 includes a transfer lock portion 53A, and is a rotating member which can rotate around a rotating center 53B. The tray 51 includes a transfer linking portion 51A, that is an engaging portion which engages with the transfer unit 40. The transfer linking portion 51A is disposed on one end portion of the tray 51 in the longitudinal direction and the width direction, and is formed so as to protrude from the outer side to the inner side in the width direction.

The transfer unit 40 includes the driving roller 46, the tension roller 47, and a transfer frame 48 which supports four primary transfer rollers 42. The transfer frame 48 includes a tray linking groove 48A and a lock linking portion 48B, and is a support member which extends from one end portion to the other end portion of the transfer unit 40 in the longitudinal direction. The tray linking groove 48A is an engaged portion that opens in the width direction of the transfer unit 40 and in the second attaching direction Da2, and engages with the transfer linking portion 51A. The lock linking portion 48B is an engaged portion located on the rotating locus of the lock member 53, and engages with the lock member 53.

The tray linking groove 48A includes a surface facing the second attaching direction Da2, and two surfaces which extend from this surface in the second attaching direction Da2 and face each other. In the state where the tray unit 50 is located at the first inner position and the transfer unit 40 is located at the second inner position, the transfer linking portion 51A is located on the inner side of the tray linking groove 48A as illustrated in FIG. 9. Here the transfer linking portion 51A is disposed with a gap from the three surfaces constituting the tray linking groove 48A.

By the tray linking groove 48A and the transfer linking portion 51A, the tray unit 50 is restricted to move from the transfer unit 40 in the first detaching direction Dd1 and in the direction orthogonal to the first detaching direction Dd1. The transfer unit 40, on the other hand, is restricted to move from the tray unit 50 in the second attaching direction Da2 and in the direction orthogonal to the second attaching direction Da2. In other words, the tray unit 50 and the transfer unit 40 mutually restrict each other to move relative to each other in a predetermined direction beyond the gap between the tray linking groove 48A and the transfer linking portion 51A.

The tray linking groove 48A and the transfer linking portion 51A are disposed at a total of four locations: near both end portions of the tension roller 47 in the rotation shaft direction of the tension roller 47; and near both end portions of the driving roller 46 in the rotation shaft direction of the driving roller 46. In other words, the engagement configuration of the tray unit 50 and the transfer unit 40 are disposed at both end portions of the tray unit 50 and the transfer unit 40 in the longitudinal direction, and at both end portions of the tray unit 50 and the transfer unit 40 in the width direction. Therefore, the tray unit 50 can support the transfer unit 40 by the transfer linking portion 51A contacting the tray linking groove 48A from the bottom. Further, the transfer unit 40 can support the tray unit 50 by the tray linking groove 48A contacting the transfer linking portion 51A from the bottom.

The lock member 53 is configured to rotate around the rotating center 53B so that the transfer lock portion 53A can be movable between a linking position where the transfer lock portion 53A is engaged with the lock linking portion 48B, and a release position where the transfer lock portion 53A is separated and disengaged from the lock linking portion 48B.

The lock linking portion 48B is formed in a groove shape, including a surface facing the first detaching direction Dd1 and a surface which opposes this surface and faces the first attaching direction Da1. In the state where the lock member 53 is located at the linking position, the transfer lock portion 53A is located between the surface facing the first detaching direction Dd1 and the surface, which is opposite this surface and faces the first attaching direction Da1. Therefore, when the lock member 53 is located at the linking position, the tray unit 50 is restricted to move from the transfer unit 40 in the first detaching direction Dd1. In the same manner, when the lock member 53 is located at the linking position, the transfer unit 40 is restricted to move from the tray unit 50 in the second detaching direction Dd2. However, in the state where the lock member 53 is at the linking position, some play (clearance) may exist between the transfer lock portion 53A and the lock linking portion 48B in the first detaching direction Dd1 and the first attaching direction Da1.

The lock linking portion 48B and the lock member 53 may be disposed at the end portions of the transfer unit 40 and the tray unit 50 in the width direction respectively. In other words, at least two lock linking portions 48B may be disposed on the transfer unit 40, and a same number of lock members 53 as the number of lock linking portions 48B may be disposed on the tray unit 50.

Thus the transfer linking portion 51A and the lock member 53 have a function of a tray-side linking apparatus, and the tray linking groove 48A and the lock linking portion 48B have a function of a transfer-side linking apparatus. By linking (engaging) the tray-side linking apparatus and the transfer-side linking apparatus, the tray unit 50 and the transfer unit 40 are linked (engaged), and the tray unit 50 and the transfer unit 40 can move together.

The apparatus main body 1A also includes a lock releasing portion 1B, as illustrated in FIG. 10. The lock releasing portion 1B is a portion to move the lock member 53 from the transfer position to the releasing position. In a state where the tray unit 50 is at the first inner position and the transfer unit 40 is at the second inner position, the lock releasing portion 1B contacts the lock member 53 such that the lock member 53 is lifted up from the lock linking portion 48B, and the lock member 53 is located at the releasing position. In this state, the transfer lock portion 53A is separated from the lock linking portion 48B, and the movement of the transfer unit 40 from the tray unit 50 in the second detaching direction Dd2 is not restricted.

When the tray unit 50 is moved in the first detaching direction Dd1 in the state where the lock member 53 is at the releasing position, the transfer unit 40 (tray linking groove 48A) is pushed by the transfer linking portion 51A in the second detaching direction Dd2. As a result, the transfer unit 40 is also moved in the second detaching direction Dd2 together with the tray unit 50. When the tray unit 50 moves for a predetermined distance in the first detaching direction Dd1, the lock member 53 is separated from the lock releasing portion 1B, and moves to the linking position and is engaged with the lock linking portion 48B. Therefore, in the step of drawing the tray unit 50 out of the apparatus main body 1A, the lock member 53 moves from the releasing position to the linking position. Then in the state where the lock member 53 is located at the linking position and is engaged with the lock linking portion 48B, the tray unit 50 is moved to the first outer position, and the transfer unit 40 is moved to the second outer position.

In the state where the tray unit 50 is located at the first outer position and the transfer unit 40 is located at the second outer position, the lock member 53 is located at the linking position and is engaged with the lock linking portion 48B. If the tray unit 50 is moved in the first attaching direction Da1 in the state where the lock member 53 is engaged with the lock linking portion 48B, the transfer unit 40 (lock linking portion 48B) is pushed by the lock member 53 in the second attaching direction Da2. As a result, the transfer unit 40 is also moved in the second attaching direction Da2 together with the tray unit 50.

When the transfer unit 40 is moved in the second attaching direction Da2 in the state where the lock member 53 is engaged with the lock linking portion 48B, the tray unit 50 (transfer linking portion 51A) is pushed by the tray linking groove 48A in the first attaching direction Da1. As a result, the tray unit 50 is also moved in the first attaching direction Da1 together with the transfer unit 40.

The lock releasing portion 1B has a sloped surface at the end portion in the first detaching direction Dd1, and the sloped surface inclines upward in the first attaching direction Da1. In the step of the tray unit 50 moving from the first outer position to the first inner position, the lock member 53 contacts this sloped surface and gradually rotates in the direction separate from the lock linking portion 48B. Then when the lock member 53 overcomes the sloped surface of the lock releasing portion 1B, the lock member 53 is supported by the lock releasing portion 1B, and locates at the releasing position.

As mentioned above, in the case of moving the tray unit 50 and the transfer unit 40 together into the apparatus main body 1A, the lock member 53 is moved to the releasing position by the lock releasing portion 1B. In this state, the transfer unit 40 does not move, even if the tray unit 50 is moved in the first attaching direction Da1. On the other hand, in the step of closing the door 20, the transfer unit 40 is pushed in the second attaching direction Da2 by the force generated when the secondary transfer roller 45 contacts the transfer unit 40, and is pushed deep into the apparatus main body 1A (to the second inner position). In other words, the door 20 can push the transfer unit 40 so that the transfer unit 40 is located at the second inner position. The door 20 may also be configured to push the tray unit 50 in the same manner, so that the tray unit 50 is located at the first inner position.

On the other hand, if the transfer unit 40 is moved in the second detaching direction Dd2 in the state where the lock member 53 is at the releasing position and the tray unit 50 is at the first inner position, the transfer unit 40 can move from the second inner position to the second outer position independently from the tray unit 50. Therefore, in the printer 1 according to Embodiment 1, the transfer unit 40 can be moved outside (second outer position) the apparatus main body 1A in the state where the tray unit 50 is located inside (first inner position) the apparatus main body 1A, as illustrated in FIG. 5. The transfer unit 40, located at the second outer position, can be detached from the apparatus main body 1A and the user can replace the transfer unit 40 with a new unit.

In Embodiment 1, in the state where the tray unit 50 is located at the first inner position, the tray unit 50 is positioned with respect to the apparatus main body 1A independently from the transfer unit 40. Further, in the state where the transfer unit 40 is located at the second inner position, the transfer unit 40 is positioned with respect to the apparatus main body 1A independently from the tray unit 50. By this configuration, the transfer unit 40 and the tray unit 50 can be accurately positioned respectively with respect to the apparatus main body 1A. For this, a clearance is created between the tray linking groove 48A and the transfer linking portion 51A in the state where the tray unit 50 is located at the first inner position and the transfer unit 40 is located at the second inner position.

This clearance between the tray linking groove 48A and the transfer linking portion 51A may be eliminated in the state where the tray unit 50 is located at the first inner position and the transfer unit 40 is at the second inner position, so that the tray unit 50 and the transfer unit 40 can be position with respect to each other. In this case, the transfer unit 40 and the tray unit 50 can be accurately positioned with respect to each other.

### Attitudes and Moving Directions of Tray Unit and Transfer Unit

Attitudes and moving directions of the tray unit 50 and the transfer unit 40 will be described in detail next. As illustrated in FIGS. 1, 6 and 7, the tray unit 50 and the transfer unit 40 are inclined from the horizontal direction (front-back direction H) in the state of being attached to the apparatus main body 1A. In other words, in the state where the tray unit 50 and the transfer unit 40 are attached to the apparatus main body 1A, the longitudinal direction of the tray unit 50 and the longitudinal direction of the transfer unit 40 intersect with the horizontal direction.

In the state where the tray unit 50 is located at the first inner position, the rotation shaft line of the photosensitive drum 61 of the cartridge PY, which is closest to the first end portion 1b1, is located above the rotation shaft line of the photosensitive drum 61 of the cartridge PK, which is most distant from the first end portion 1b1, in the vertical direction V.

This will be described in more detail assuming that the four photosensitive drums 61, in the state where the tray unit 50 is located at the first inner position, are called a first photosensitive drum, a second photosensitive drum, a third photosensitive drum, and a fourth photosensitive drum in order from the most distant from the first end portion 1b1. The second photosensitive drum is closer to the first end portion 1b1 than the first photosensitive drum is to the first end portion 1b1, and the rotation shaft line of the second photosensitive drum is located above the rotation shaft line of the first photosensitive drum in the vertical direction V. In the same manner, the third photosensitive drum is closer to the first end portion 1b1 than the second photosensitive drum is to the first end portion 1b1, and the rotation shaft line of the third photosensitive drum is located above the rotation shaft line of the second photosensitive drum in the vertical direction V. The fourth photosensitive drum is closer to the first end portion 1b1 than the third photosensitive drum is to the first end portion 1b1, and the rotation shaft line of the fourth photosensitive drum is above the rotation shaft line of the third photosensitive drum in the vertical direction V.

Here a line connecting the rotation center of each photosensitive drum 61 is assumed to be a line LD. The line LD extends in a direction parallel with the longitudinal direction of the tray unit 50. In Embodiment 1, when the tray unit 50 is located at the first inner position, the line LD inclines upward with respect to the horizontal direction, from the side distant from the first end portion 1b1 to the side close to the first end portion 1b1.

A contact surface of the belt 41 contacting the first photosensitive drum, the second photosensitive drum, the third photosensitive drum and the fourth photosensitive drum incline upward from the side distant from the first end portion 1b1 to the side close to the first end portion 1b1. This contact surface is a surface which extends in a direction parallel with the longitudinal direction of the transfer unit 40, and is a surface which extends in a direction parallel with the line connecting the rotation center of the driving roller 46 and the rotation center of the tension roller 47.

When the tray unit 50 moves from the first inner position to the first outer position, the tray unit 50 first moves in the direction inclined from the horizontal direction (direction inclined upward with respect to the horizontal direction in Embodiment 1). In other words, when the tray unit 50 moves from the first inner position to the first outer position, the tray unit 50 moves obliquely upward. Then the moving direction of the tray unit 50 changes from an obliquely upward direction to an obliquely downward direction. In Embodiment 1, the moving direction (first detaching direction Dd1) of the tray unit 50 changes from an obliquely upward direction to the horizontal direction, but the present disclosure is not limited to this configuration. For example, the moving direction of the tray unit 50 may include an obliquely downward direction from the horizontal direction. The first attaching direction Da1 of the tray unit 50, on the other hand, changes from the horizontal direction to an obliquely downward direction.

The angle formed by the line LD and the horizontal direction is smaller when the tray unit 50 is located at the first outer position than when the tray unit 50 is located at the first inner position. In Embodiment 1, the line LD is parallel with the horizontal direction when the tray unit 50 is located at the first outer position, but the present disclosure is not limited to this configuration. For example, the line LD may be inclined from the horizontal direction when the tray unit 50 is located at the first outer position.

In the same manner, when the transfer unit 40 moves from the second inner position to the second outer position, the moving direction (second detaching direction Dd2) of the transfer unit 40 changes from an obliquely upward direction to an obliquely downward direction. In Embodiment 1, the moving direction of the transfer unit 40 changes from the diagonally upward direction to the horizontal direction, but the present disclosure is not limited to this. For example, the moving direction of the transfer unit 40 may include an obliquely downward direction from the horizontal direction. The second attaching direction Da2 of the transfer unit 40, on the other hand, changes from the horizontal direction to an obliquely downward direction.

The angle formed by the longitudinal direction of the transfer unit 40 and the horizontal direction is smaller when the transfer unit 40 is located at the second outer position than when the transfer unit 40 is located at the second inner position. In Embodiment 1, the longitudinal direction of the transfer unit 40 is parallel with the horizontal direction when the transfer unit 40 is located at the second outer position, but the contact surface of the belt 41 may be inclined downward or upward from the horizontal direction.

In the case of moving the tray unit 50 from the first outer position to the first inner position, the tray unit 50 moves in the horizontal direction first, and then moves obliquely downward en route. In the case of moving the transfer unit 40 from the second outer position to the second inner position, the transfer unit 40 moves in the horizontal direction first, and then moves obliquely downward en route. By this configuration, when the tray unit 50 and the transfer unit 40 are inserted into the apparatus main body 1A, the dead weights of the tray unit 50 and the transfer unit 40 can be utilized.

### Moving Path of the Transfer Unit

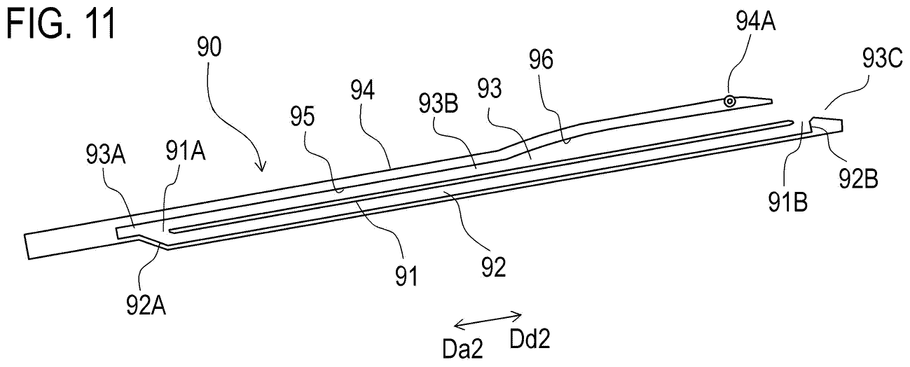

The moving path of the transfer unit 40 will now be described in detail with reference to FIGS. 11, 12, 13A, 13B and 14. As illustrated in FIG. 4, a main guide 90 has been installed in the main frame 100. The main guide 90 is an engaging member which engages with the transfer unit 40, and regulates the moving direction of the transfer unit 40.

FIG. 11 is a diagram for describing the configuration of the main guide 90. The main guide 90 includes an upper guide region 93 and a lower guide region 92 which are vertically partitioned by a wall 91. The upper guide region 93 and the lower guide region 92 are grooves which are formed in the main guide 90 and open in the left-right direction. As illustrated in FIG. 8, a transfer shaft 49, which is a shaft-like projection extending in the width direction (direction orthogonal to the second detaching direction Dd2), is disposed in the transfer unit 40. The transfer shaft 49 is a projection which enters the grooves of the upper guide region 93 and the lower guide region 92, and is an engaged portion which is engaged with the main guide 90. In Embodiment 1, the transfer shaft 49 is disposed at the end portion on the downstream side of the transfer unit 40 in the second attaching direction Da2.

The lower guide region 92 is a path which branches from the upper guide region 93 and extends parallel with the upper guide region 93. The lower guide region 92 is disposed at a position more distant from the tray unit 50, which is inside the apparatus main body 1A, than the upper guide region 93 is from the tray unit 50 located inside the apparatus main body 1A. In Embodiment 1, the upper guide region 93 and the lower guide region 92 extend approximately parallel, but the present disclosure is not limited to this configuration, and the lower guide region 92 may extend inclined from the upper guide region 93.

On the downstream side in the second attaching direction Da2 (upstream side in the second attaching direction Dd2) of the wall 91, a notch portion 91A is disposed as an opening to connect the upper guide region 93 and the lower guide region 92. Further, on the downstream side in the second detaching direction Dd2 of the wall 91, a notch portion 91B is disposed as the opening to connect the upper guide region 93 and the lower guide region 92. The notch portion 91A and the notch portion 91B function as connecting portions respectively to connect the upper guide region 93 and the lower guide region 92. In the second detaching direction Dd2, the notch portion 91A is disposed on the upstream side of the wall 91, and the notch portion 91B is disposed on the downstream side of the wall 91.

At the end portion of the lower guide region 92 on the downstream side in the second attaching direction Da2, a sloped surface 92A, which inclines upward in the second attaching direction Da2, is disposed. At the end portion of the lower guide region 92 on the downstream side in the second detaching direction Dd2, a detent portion 92B, which extends in a direction intersecting with (can be orthogonal to) the second detaching direction Dd2, is disposed.

The upper guide region 93 includes a first region 93A at the end portion on the downstream side in the second attaching direction Da2, a second region 93B which extends parallel with the lower guide region 92, and a third region 93C at the end portion on the downstream side in the second detaching direction Dd2. The first region 93A includes a portion located on the downstream side in the second attaching direction Da2 with respect to the notch portion 91A. The second region 93B is partitioned from the lower guide region 92 by the wall 91, and is connected to the lower guide region 92 via the notch portion 91A and the notch portion 91B. The third region 93C includes a portion located on the downstream side in the second detaching direction Dd2 with respect to the notch portion 91B.

A tray unit support portion 94 is disposed at an upper portion of the main guide 90. The tray unit support portion 94 is configured to support the tray unit 50 from the bottom. The configuration to support and guide the tray unit 50 may be disposed independently from the tray unit support portion 94.

When the transfer unit 40 and the tray unit 50 are moved out together, the second region 93B of the upper guide region 93 functions as a first path where the transfer shaft 49 passes. Further, when the transfer unit 40 is moved out independently from the tray unit 50, the lower guide region 92, which branches from the second region 93B, functions as a second path where the transfer shaft 49 passes. The moving paths of the transfer unit 40 in the case where the transfer unit 40 is moved out independently from the tray unit 50, and in the case where the transfer unit 40 is moved out together with the tray unit 50, will be described in detail respectively.

Moving Path when Transfer Unit Moves Independently from Tray Unit

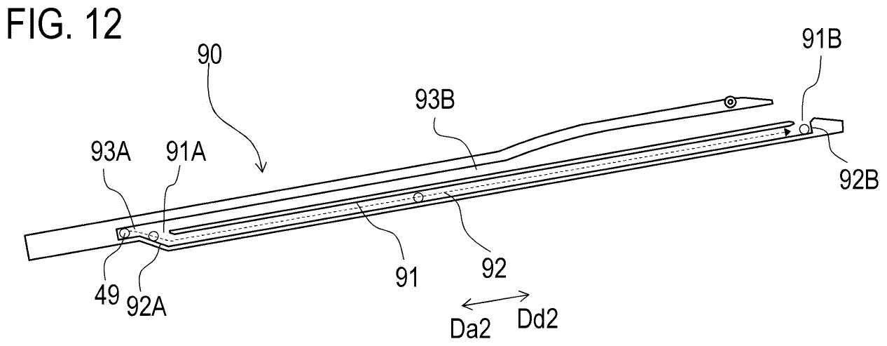

The moving path of the transfer unit 40 when the transfer unit 40 moves independently from the tray unit 50 will be described in detail. FIG. 12 is a diagram for describing the moving path of the transfer unit 40, and the broken line indicates a path (locus) of the transfer shaft 49 when the transfer unit 40 moves from the second inner position to the second outer position independently from the tray unit 50.

When the transfer unit 40 is located at the second inner position, the transfer shaft 49 is located within the first region 93A of the upper guide region 93. As illustrated in FIG. 12, when the transfer unit 40 moves alone from the second inner position to the second outer position, the transfer shaft 49 passes from the first region 93A of the upper guide region 93 of the main guide 90 to the notch portion 91A, then enters the lower guide region 92 along the sloped surface 92A. When the transfer unit 40 is moved out independently from the tray unit 50, the notch portion 91A functions as an inlet for the transfer shaft 49 to enter the lower guide region 92. Then the transfer unit 40 moves in the second detaching direction Dd2 while being guided by the main guide 90, so that the transfer shaft 49 passes the lower guide region 92. If the transfer unit 40 is lifted after the transfer shaft 49 moved until abutting the detent portion 92B, the transfer shaft 49 passes the notch portion 91B, and the transfer unit 40 can be detached from the apparatus main body 1A. When the transfer unit 40 is moved out independently from the tray unit 50, the notch portion 91B functions as an outlet for the transfer shaft 49 to exit the lower guide region 92. The second outer position of the transfer unit 40 is the position where the transfer shaft 49 abuts the detent portion 92B.

When the transfer unit 40 is moved to the second inner position in the state where the tray unit 50 is attached to the apparatus main body 1A, the transfer unit 40 passes the above mentioned moving locus in the opposite direction. In other words, the transfer shaft 49 enters the lower guide region 92 through the notch portion 91B, passes the lower guide region 92 along the extending direction thereof, moves up the sloped surface 92a, and reaches the first region 93A of the upper guide region 93.

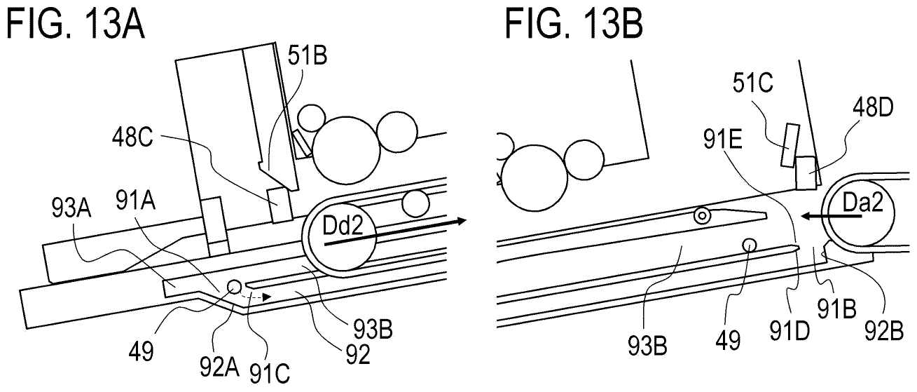

FIGS. 13A and 13B are diagrams for describing the structure to prevent entry errors of the transfer shaft 49. FIG. 13A indicates the end portion of the main guide 90 on the upstream side in the second detaching direction Dd2. FIG. 13B indicates the end portion of the main guide 90 on the upstream side in the second attaching direction Da2.

When the transfer unit 40 starts to move from the second inner position to the second outer position, the transfer shaft 49 moves from the first region 93A of the upper guide region 93 to the sloped surface 92A through the notch portion 91A by the dead weight of the transfer unit 40. However, if the transfer unit 40 is lifted and moved, the transfer shaft 49 may enter the second region 93B of the upper guide region 93. Therefore, in Embodiment 1, a preventive wall 51B is disposed in the tray unit 50, as a restricting portion (first restricting portion) to prevent the transfer shaft 49 from moving into the second outer position through the second region 93B when the transfer unit 40 moves independently from the tray unit 50. Further, as illustrated in FIG. 13A, an abutting portion 48C is disposed in the transfer unit 40. If the transfer shaft 49 attempts to enter the second region 93B in the state where the tray unit 50 is located at the first inner position, the abutting portion 48C abuts the preventive wall 51B of the tray unit 50, and entry of the transfer shaft 49 into the second region 93B is restricted. When the abutting portion 48C contacts the preventive wall 51B, the transfer shaft 49 is located on the upstream side of the wall 91 in the second detaching direction Dd2. Specifically, when the abutting portion 48C contacts the preventive wall 51B in the second detaching direction Dd2, the position of the transfer shaft 49 overlaps with the position of the notch portion 91A in the second detaching direction Dd2. The entry error restriction structure is configured such that when the abutting portion 48C contacts the preventive wall 51B, the transfer shaft 49 is located at the notch portion 91A, which is a connecting portion between the second region 93B and the lower guide region 92.

The preventive wall 51B has a sloped surface which inclines in the direction of approaching the lower guide region 92 in the first detaching direction Dd1, and the abutting portion 48C contacts this sloped surface. Therefore, if an attempt is made to draw out the transfer unit 40 in the state where the abutting portion 48C is in contact with the preventive wall 51B, the transfer unit 40 receives a force through the abutting portion 48C from the preventive wall 51B in the direction of approaching the lower guide region 92. In other words, the sloped surface of the preventive wall 51B guides the abutting portion 48C so that the transfer shaft 49 approaches the lower guide region 92 as the transfer unit 40 is moved out of the apparatus main body 1A. By this configuration, the transfer shaft 49 can be guided to the lower guide region 92 while restricting the transfer shaft 49 from advancing to the second region 93B in the second detaching direction Dd2.

Further, the printer 1, according to Embodiment 1, includes a regulating structure 70 to restrict the tray unit 50 from moving in the first detaching direction Dd1 in a state where the abutting portion 48C is in contact with the preventive wall 51B, and is moved out of the apparatus main body 1A. By disposing this regulating structure 70, the transfer unit 40 can be prevented from being moved out together with the tray unit 50 in the state where the abutting portion 48C is in contact with the preventive wall 51B. Details of the regulating structure 70 will be described later.

Furthermore, a lower sloped surface portion 91C, which inclines downward in the second detaching direction Dd2, is formed at the end portion on the upstream side of the wall 91 in the second detaching direction Dd2. When the transfer shaft 49, moving in the second detaching direction Dd2, contacts the lower sloped surface portion 91C, the transfer shaft 49 receives a force in the downward direction from the lower sloped surface portion 91C, hence the transfer shaft 49 is more easily guided into the lower guide region 92 by the lower sloped surface portion 91C. By this configuration, when the transfer unit 40 is moved out of the apparatus main body 1A independently, the transfer shaft 49 passes the lower guide region 92 with certainty, and the transfer unit 40 can move without interfering with the photosensitive drum 61.

When the transfer unit 40 is located at the second outer position, the transfer shaft 49 abuts the detent portion 92B. In this state, the end portion of the transfer unit 40 on the downstream side in the second detaching direction Dd2 is supported by the support portion (not illustrated) of the door 20, and a center of gravity G1 (see FIG. 5) of the transfer unit 40 is located between the transfer shaft 49 and this end portion. Therefore, when the transfer unit 40 moves alone from the second outer position to the second inner position, the transfer shaft 49 passes the lower guide region 92. Then the transfer shaft 49 moves along the lower guide region 92, moves up the sloped surface 92A, and reaches the upper guide region 93.

However in the case where the transfer unit 40 is lifted and moved into the apparatus main body 1A in this state (e.g. case of replacing the transfer unit 40), the transfer shaft 49 may enter the second region 93B of the upper guide region 93. To prevent this, in Embodiment 1, in the case where the transfer unit 40 is moved (inserted) alone into the apparatus main body 1A when the tray unit 50 is located at the first inner position, a preventive wall 51C is disposed in the tray unit 50. The preventive wall 51C functions as a restricting portion (second restricting portion) to restrict the transfer shaft 49 from passing the second region 93B of the upper guide region 93 and the transfer unit 40 from reaching the second inner position. Further, as illustrated in FIG. 13B, an abutting portion 48D is disposed in the transfer unit 40. When the transfer shaft 49 enters the second region 93B, the abutting portion 48D abuts the preventive wall 51C of the tray unit 50, and moving the transfer unit 40 in the second attaching direction Da2 is restricted. In Embodiment 1, when the abutting portion 48C contacts the preventive wall 51B, the transfer shaft 49 is located in the second region 93B, but when the abutting portion 48C contacts the preventive wall 51B, the position of the transfer shaft 49 and the position of the notch portion 91B may overlap in the second attaching direction Da2.

The preventive wall 51C has a sloped surface, which inclines in a direction of approaching the lower guide region 92 in the first attaching direction Da1, and the abutting portion 48D contacts this sloped surface. Therefore, if an attempt is made to insert the transfer unit 40 into the apparatus main body 1A in the state where the abutting portion 48D is in contact with the preventive wall 51C, moving up of the transfer unit 40 can be prevented.

Further, at the end portion of the wall 91 on the upstream side in the second attaching direction Da2, a lower sloped surface portion 91D, which inclines downward in the second attaching direction Da2, and an upper sloped surface portion 91E which inclines upward in the second attaching direction Da2, are formed. The lower sloped surface portion 91D is disposed such that the transfer shaft 49 can be easily guided into the lower guide region 92.

As described above, when the transfer unit 40 moves independently from the tray unit 50, the transfer shaft 49 passes the lower guide region 92. Therefore, the transfer unit 40 can move in the second detaching direction Dd2 and the second attaching direction Da2 at a position which is separated from the tray unit 50 in the downward direction. By this configuration, the transfer unit 40 can smoothly move between the second inner position and the second outer position without scratching the photosensitive drum 61, in a state where the belt 41 and the like are separated from the photosensitive drum 61.

Moving Path when Transfer Unit Moves Together with Tray Unit

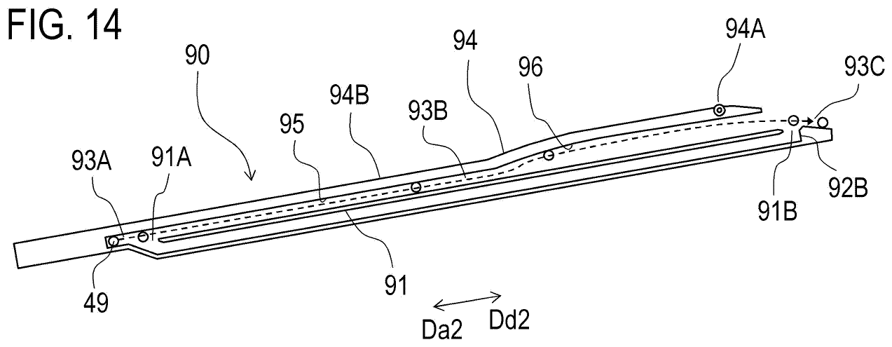

Next the moving path of the transfer unit 40 when the transfer unit 40 moves together with the tray unit 50 will be described in detail. FIG. 14 is a diagram for describing the moving path of the transfer unit 40, and the broken line indicates a path (locus) of the transfer shaft 49 when the transfer unit 40 moves together with the tray unit 50 from the second inner position to outside the apparatus main body 1A.

When the tray unit 50, linked with the transfer unit 40, moves from the first inner position to the first outer position, the lower surface of the tray unit 50 is supported by the tray unit support portion 94. The transfer unit 40, on the other hand, moves together with the tray unit 50 while being supported from the bottom by the transfer linking portion 51A of the tray unit 50. Therefore, in the case where the transfer unit 40 moves together with the tray unit 50, the transfer shaft 49 enters the second region 93B without dropping into the lower guide region 92, and moves along the upper guide region 93. In the configuration of Embodiment 1, the main guide 90 supports the tray unit 50, but a support member different from the main guide 90 may support the tray unit 50.

A rotatable roller 94A is disposed at the end portion of the tray unit support portion 94 in the second detaching direction Dd2. Since the tray unit 50 can smoothly move on the roller 94A, a load when the user draws out the tray unit 50 can be reduced.

When the center of gravity G2 of the tray unit 50 and the transfer unit 40 (see FIG. 4) is on the downstream side of the roller 94A in the second attaching direction Da2, the tray unit 50 moves while supported by the tray unit support portion 94. Here the tray unit 50 moves while supported by the roller 94A and a surface 94B on the downstream side of the roller 94A in the second attaching direction Da2.

When the center of gravity G2 of the tray unit 50 and the transfer unit 40 is on the downstream side of the roller 94A in the second detaching direction Dd2, a lower surface 51D of the tray unit 50 is separated from the surface 94B of the tray unit support portion 94, and the tray unit 50 moves while supported by the roller 94A. The upper surface of the second region 93B of the upper guide region 93 includes a flat surface portion 95 which extends linearly, and a curved surface portion 96 which arcs upward from the end of the wall 91 on the downstream side in the second detaching direction Dd2. When the transfer shaft 49 passes the second region 93B of the upper guide region 93, the transfer shaft 49 contacts the flat surface portion 95 and the curved surface portion 96, whereby the inclination of the tray unit 50 and the transfer unit 40 during movement is restricted.

If the tray unit 50 and the transfer unit 40 are further moved out in the state where the transfer shaft 49 is located in the second region 93B, the transfer shaft 49 slides on the curved surface portion 96, and the attitudes of the tray unit 50 and the transfer unit 40 change from the inclined state to the horizontal state. Then the transfer unit 40 is supported by the support portion of the door 20, and the tray unit 50 is supported by the door 20 via the transfer unit 40. Here the tray linking groove 48A of the transfer unit 40 supports the transfer linking portion 51A of the tray unit 50 from the bottom. The position of the tray unit 50, where the tray unit 50 is supported by the door 20 via the transfer unit 40 and the cartridge P and the tray unit 50 are detachable from the apparatus main body 1A, is the first outer position. When the transfer unit 40 is moved out of the apparatus main body 1A together with the tray unit 50, the transfer unit 40 is supported by the support portion of the door 20 at a position different from the second outer position. In other words, the position where the transfer unit 40 and the tray unit 50 are moved out together (first position) and the position where the transfer unit 40 is moved out independently from the tray unit 50 (second position, second outer position) are different. In Embodiment 1, the second position is closer to the apparatus main body 1A than the first position is to the apparatus main body 1A.

The lower surface of the transfer unit 40 is supported by the support portion of the door 20 in both the case where the transfer unit 40 alone is moved out of the apparatus main body, and the case where the transfer unit 40 is moved out of the apparatus main body in the state of being linked with the tray unit 50. The transfer unit 40 is detachable from the apparatus main body 1A at the second outer position (second position).

As mentioned above, when the tray unit 50 moves from the first outer position to the first inner position together with the transfer unit 40, the transfer unit 40 is supported by the tray unit 50 from the bottom. Therefore, the transfer shaft 49 can move through the notch portion 91B without dropping into the lower guide region 92. Further, the upper sloped surface portion 91E is disposed at the end portion of the wall 91 of the main guide 90 on the upstream side in the first attaching direction Da1, hence the transfer shaft 49 can be prevented from becoming hooked on the wall 91.

When the tray unit 50 moves from the first outer position to the first inner position together with the transfer unit 40, and the transfer shaft 49 contacts the curved surface portion 96 at this time, the transfer shaft 49 receives a downward force with the roller 94A as a fulcrum. Then the tray unit 50 receives a force in the direction of lifting the tray handle 52 via the transfer unit 40. As a result, the tray unit 50 and the transfer unit 40 move while changing the attitudes along the curved surface portion 96. Then when the center of gravity G2 moves to the downstream side of the roller 94A in the second attaching direction Da2, the tray unit 50 drops into the first inner position by its dead weight.

As mentioned above, in the case where the transfer unit 40 moves together with the tray unit 50, the transfer shaft 49 passes the upper guide region 93, and the tray unit 50 can smoothly move between the first inner position and the first outer position.

In the above description, the main guide 90, disposed on one end side of the tray unit 50 and the transfer unit 40 in the width direction, was described, but a guide member (engaging member) which has a shape symmetric with the main guide 90 is also disposed on the other end side of the tray unit 50 and the transfer unit 40 in the width direction. In other words, the transfer unit 40, engaged with the engaging members disposed on the apparatus main body 1A on both sides in the width direction, moves between the inner side and the outer side of the apparatus main body 1A in this state.

In the configuration described above, the transfer unit 40 can pass a plurality of paths, but the present disclosure is not limited to this configuration. For example, a first unit and a second unit different from the transfer unit 40 and the tray unit 50 may be disposed. In this case as well, the second unit can be configured to pass different paths when the second unit is moved out of the apparatus main body 1A together with the first unit, and when the second unit is moved out of the apparatus main body 1A from the first unit. The first unit and the second unit in this case may be standalone parts or members.

### Regulating Structure of Tray Unit

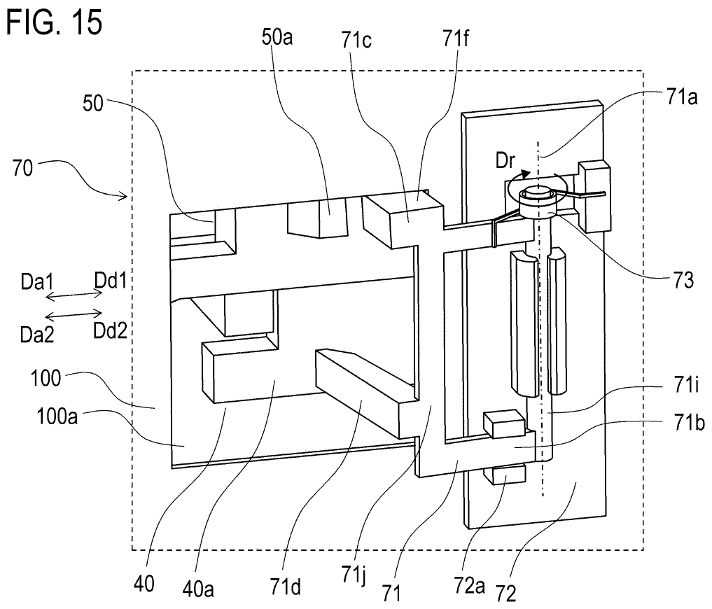

The regulating structure 70 to regulate the movement of the tray unit 50 will be described with reference to FIGS. 15, 16A to 16C and 17. The tray unit 50 is supported by the door 20 via the transfer unit 40 at the first outer position, hence if the tray unit 50 is moved out to the first outer position independently, appropriate support by the door 20 may not be received. In other words, the tray unit 50 can be configured to not move to the first outer position when the transfer unit 40 is at the second outer position or in the process of moving to the second outer position. Therefore, the printer 1, according to Embodiment 1, includes the regulating structure 70 (see FIG. 5) which regulates the tray unit 50 to not move outside the apparatus main body 1A independently.

FIG. 15 is a perspective view depicting the configuration of the regulating structure 70. The regulating structure 70 includes: a regulating member 71 which regulates the tray unit 50 to not move to the first outer position when the transfer unit 40 is located at a position distant from the second inner position; a holding member 72 which holds the regulating member 71; and a spring 73 which energizes the regulating member 71. The regulating member 71 is held by the holding member 72, so as to be rotatable around a rotation shaft line 71a. The regulating member 71 is configured so as to be rotatable between a non-regulating position where movement of the tray unit 50 is not regulated, and a regulating position where movement of the tray unit 50 is regulated. The rotation shaft line 71a extends in a direction intersecting (can be orthodontal to) the longitudinal direction and the width direction of the tray unit 50, which is located at the first inner position. The regulating member 71 also includes a positioned portion 71b, which engages with (contacts) a positioning portion 72a of the holding member 72 so as to determine the position in a direction parallel with the rotation shaft line 71a.

The holding member 72 is disposed on the opposite side surface of the surface facing the tray unit 50 of the main frame 100 of the printer 1. In other words, the main frame 100 is displayed between the rotation shaft line 71a of the holding member 72 and the regulating member 71, and the tray unit 50 and the transfer unit 40.

The regulating member 71 includes: a rotation shaft portion 71i which rotates around the rotation shaft line 71a; a connecting portion 71j which extends from the rotation shaft portion 71i in a direction intersecting with the rotation shaft line 71a; a tray regulating portion 71c which extends from the connecting portion 71j in a direction intersecting with the extending direction of the connecting portion 71j and the rotation shaft line 71a; and a transfer detecting portion 71d. The connecting portion 71j extends in parallel from the top and bottom of the rotation shaft portion 71i, then the extended portions are vertically connected. The above mentioned positioned portion 71b is a part of the connecting portion 71j.

The tray regulating portion 71c is a regulating portion (contact portion) which extends from the top of the connecting portion 71j and contacts a tray lock portion 50a of the tray unit 50, so as to regulate the position of the tray unit 50. The transfer detecting portion 71d is a contact portion which extends from the bottom of the connecting portion 71j approximately parallel with the extending direction of the tray regulating portion 71c, and contacts a transfer side face 40a of the transfer unit 40. Further, an opening 100a is disposed in the main frame 100. The tray regulating portion 71c and the transfer detecting portion 71d are disposed from the rotation shaft line 71a side to the tray unit 50 (transfer unit 40) side crossing over the opening 100a. In other words, the tray regulating portion 71c and the transfer detecting portion 71d are partially located inside the opening 100a.

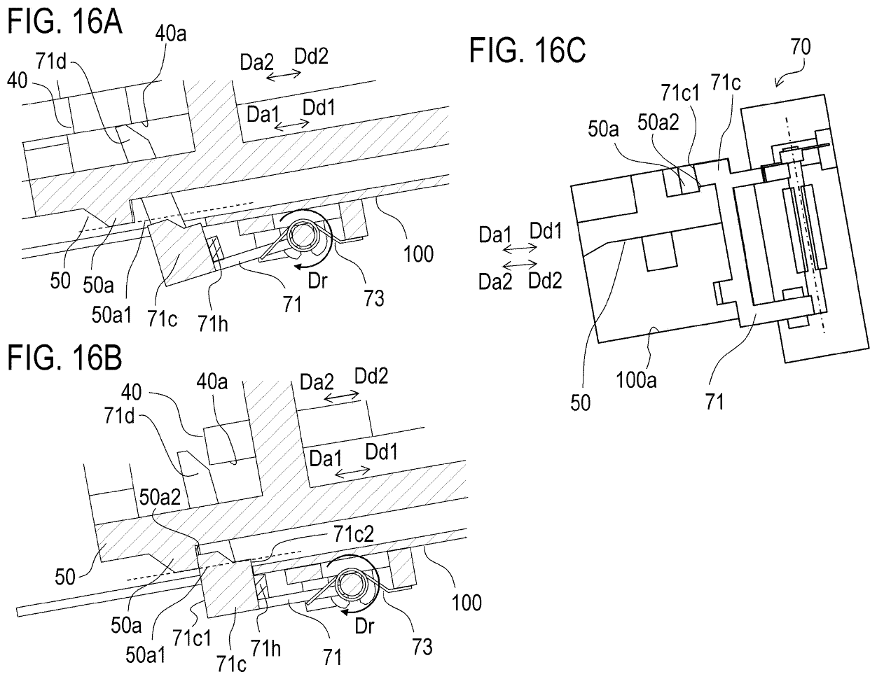

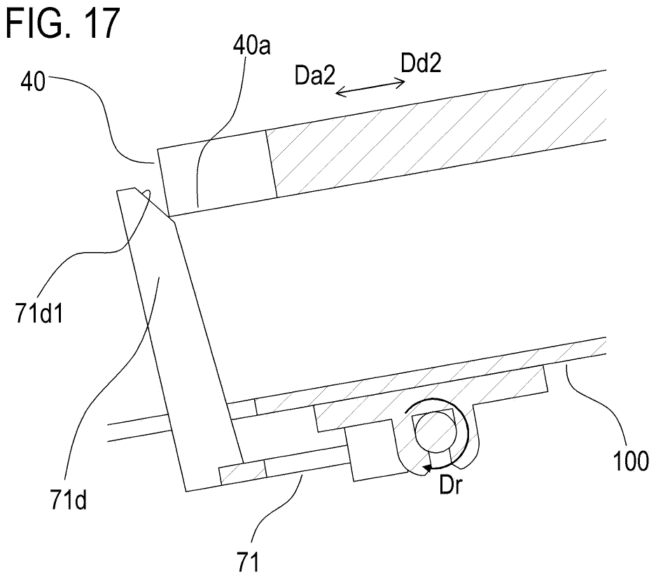

FIGS. 16A, 16B and 17 are top views of the regulating structure 70 in a direction parallel with the rotation shaft line 71a. FIG. 16C is a diagram viewing the regulating structure 70 in the left-right direction of the printer 1 (width direction of the tray unit 50). FIG. 16A indicates a state where the regulating member 71 is located at the non-regulating position, and is in contact with the transfer unit 40. When the transfer unit 40 is located at the second inner position or in the vicinity thereof, the transfer detecting portion 71d of the regulating member 71 contacts the transfer side face 40a. Here the attitude of the regulating member 71 is fixed since rotation (movement) is restricted by the transfer side face 40a, even if the transfer detecting portion 71d is energized by the spring 73 in the direction of pushing the transfer side face 40a. At this time, the tray regulating portion 71c is located outside the first space Q1, which is the moving space of the tray unit 50. Therefore, the tray unit 50 can move between the first inner position and the first outer position without being regulated by the regulating member 71.

On the other hand, when the transfer unit 40 is located at the second outer position, or when the transfer unit 40 is moving to the second outer position and is located at a position distant from the second inner position, the transfer detecting portion 71d does not contact the transfer unit 40. Then the regulating member 71 is energized by the spring 73 and rotates in an arrow Dr direction, and a frame abutting portion 71h of the regulating member 71 abuts the surface on the side of the holding member 72 of the main frame 100.

FIGS. 16B and 16C indicate a state where the regulating member 71 is located at the regulating position, and the tray unit 50 contacts the regulating member 71. When the regulating member 71 does not contact the transfer unit 40 but contacts the main frame 100, the tray regulating portion 71c is located inside the first space Q1 (moving space of the tray lock portion 50a). Specifically, the tray regulating portion 71c is located at a position overlapping with the moving locus 50al of the tray lock portion 50a, which protrudes from the end portion of the tray unit 50 in the width direction toward the rotation shaft line 71a side. Therefore, when the regulating member 71 does not contact the transfer unit 40, but contacts the main frame 100 and is positioned in this state, the tray lock portion 50a contacts the tray regulating portion 71c, and movement of the tray unit 50 in the first detaching direction Dd1 is regulated. At this time, a surface 50a2 of the tray lock portion 50a contacts a surface 71c1 of the tray regulating portion 71c, and the regulating member 71 is pushed toward the tray unit 50. Then a surface 71c2, which faces the opposite side of the surface 71c1 of the tray regulating portion 71c, contacts an edge of the opening 100a of the main frame 100.

In Embodiment 1, when the transfer unit 40 moves alone in the second detaching position Dd2 and the abutting portion 48C of the transfer unit 40 contacts the preventive wall 51B of the tray unit 50, the tray lock portion 50a contacts the regulating member 71. Therefore, when an attempt is made to draw out the transfer unit 40 independently from the tray unit 50, and the transfer unit 40 pushes the tray unit 50, the regulating structure 70 regulates the tray unit 50 from being moved out together with the transfer unit 40.

The surface 71c1 of the tray regulating portion 71c and the surface 50a2 of the tray lock portion 50a are inclined respectively with respect to the surface orthogonal to the longitudinal direction of the tray unit 50 located at the first inner position. Specifically, the surface 71c1 of the tray regulating portion 71c is inclined in a direction separate from the upper end portion of the opening 100a in the first detaching direction Dd1. In the same manner, the surface 50a2 of the tray lock portion 50a is inclined in a direction separate from the upper end portion of the opening 100a in the first detaching direction Dd1. Therefore, if the tray lock portion 50a pushes the tray regulating portion 71c in the first detaching direction Dd1, the tray regulating portion 71c is pushed from the tray lock portion 50a toward the upper edge portion of the opening 100a, and contacts this upper end portion. By this configuration, the pushing force by the tray lock portion 50a of the tray unit 50 can be distributed to the main frame 100, hence deformation of and damage to the tray regulating portion 71c can be prevented, and movement of the tray unit 50 to the tray regulating portion 71c can be regulated with more certainty.

Further, when the tray unit 50 moves from the first outer position to the first inner position, the transfer unit 40 also moves together with the tray unit 50. Then the front end of the transfer side face 40a (end portion of the transfer unit 40 in the second attaching directing Da2) contacts the sloped surface 71dl formed at the front end of the transfer detecting portion 71d. Then the regulating member 71 rotates (moves) from the regulating position to the non-regulating position, and the tray regulating portion 71c is retracted from the moving locus 50al of the tray lock portion 50a. Therefore, the regulating member 71 does not regulate the movement of the tray unit 50 in the first attaching direction Da1. In the same manner, in the case of the transfer unit 40 moving alone from the second outer position to the second inner position in the second attaching direction Da2 as well, the regulating member 71 is pushed by the transfer unit 40 and rotates against the energizing force of the spring 73. Therefore, the regulating member 71 does not regulate the movement of the transfer unit 40 in the second attaching direction Da2.

As described above, in Embodiment 1, the movement of the tray unit 50 from the first inner position to the first outer position is regulated by the regulating structure 70 when the transfer unit 40 is distant from the second inner position.

The configuration of the regulating structure is not limited to the above mentioned configuration. For example, the movement of the tray unit 50 may be regulated by a structure that includes a member which directly moves between the regulating position and the non-regulating position, instead of the rotating member which receives the energizing force.

### Modifications

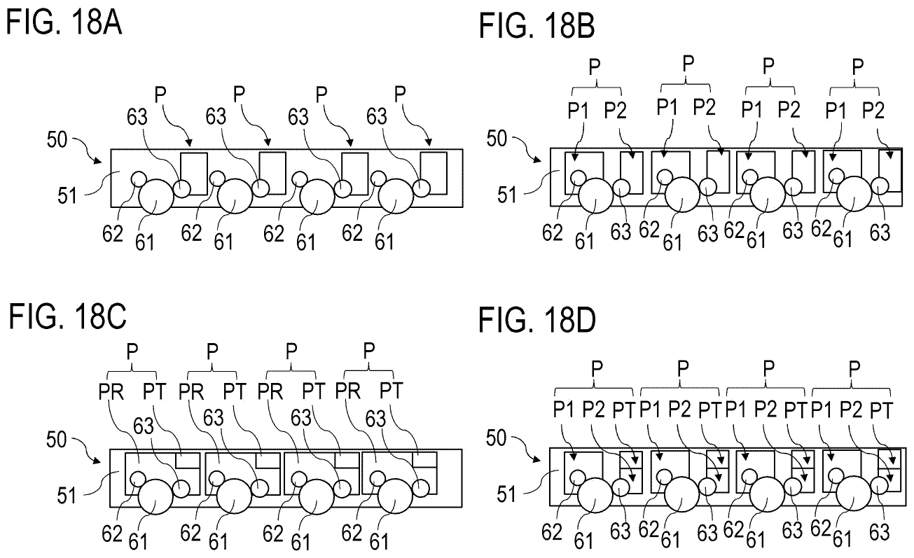

Modifications of Embodiment 1 will be described next. In Embodiment 1, the photosensitive drum 61, the charging roller 62 and the developing roller 63 are disposed in the cartridge P, but the present disclosure is not limited to this configuration. Modifications will be described with reference to FIGS. 18A to 18D as examples. FIGS. 18A to 18D are diagrams depicting the tray unit 50 according to the modifications.

For example, the tray 51 may include the photosensitive drum 61 and the charging roller 62, and the cartridge P may include the developing roller 63, as illustrated in FIG. 18A.

As another example, the cartridge P may include a drum cartridge P1 which includes the photosensitive drum 61 and the charging roller 62, and a developing cartridge P2 which includes the developing roller 63, as illustrated in FIG. 18B. In other words, the cartridge P may be separated into the drum cartridge P1 and the developing cartridge P2. In this case, the drum cartridge P1 and the developing cartridge P2 can be attachable to/detachable from the tray 51 independently from each other.

As another example, the cartridge P may include a cartridge PR which includes the photosensitive drum 61, the charging roller 62 and the developing roller 63, and a cartridge PT which includes toner to replenish the cartridge PR, as illustrated in FIG. 18C. In other words, the cartridge P may be separated into the cartridge PR and the cartridge PT.

As another example, the cartridge P may include a drum cartridge P1 which includes the photosensitive drum 61 and the charging roller 62, the developing cartridge P2 which includes the developing roller 63, and a cartridge PT which includes toner to replenish the developing cartridge P2, as illustrated in FIG. 18D. In other words, the cartridge P may be separated into the drum cartridge P1, the developing cartridge P2 and the cartridge PT.

### Embodiment 2

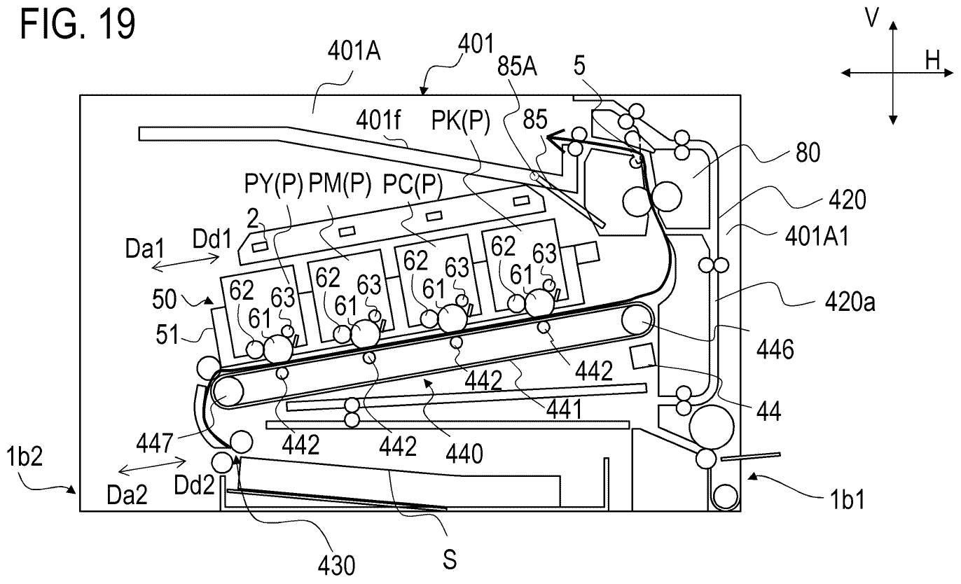

Embodiment 2 of the present disclosure will be described with reference to FIGS. 19, 20 and 21. In the following description on the configuration of Embodiment 2, a composing element the same as Embodiment 1 will be denoted with a same reference sign, and description thereof will be omitted, and portions characteristic of Embodiment 2 will be mainly described.

### Configuration of Image Forming Apparatus

FIG. 19 is a diagram depicting a general configuration of a printer 401 (image forming apparatus) according to Embodiment 2. The printer 401 (image forming apparatus) according to Embodiment 2 includes an apparatus main body 401A on which an opening 401A1 is formed, and a door 420. The printer 401 corresponds to the printer 1 of Embodiment 1, the apparatus main body 401A corresponds to the apparatus main body 1A of Embodiment 1, and the opening 401A1 corresponds to the opening 1A1 of Embodiment 1 respectively.

In Embodiment 1, a toner image, which is formed on the photosensitive drum 61, is transferred to the belt 41 of the transfer unit 40, and is then transferred from the belt 41 to the sheet S in the secondary transfer portion. In other words, the transfer unit 40 according to Embodiment 1 has a function of an intermediate transfer unit. In Embodiment 2, on the other hand, the printer 401 includes a transfer unit 440 (second unit) configured to be movable or drawable from the apparatus main body 401A, in addition to the tray unit 50 (first unit), which is the same as Embodiment 1. The transfer unit 440 conveys a sheet S using a belt (conveying belt) 441 such that the sheet S contacts with the photosensitive drum 61, and the toner image is transferred from the photosensitive drum 61 to the sheet S. In other words, the transfer unit 440 of Embodiment 2 has a function of a conveying belt unit.

The printer 401 (image forming apparatus) according to Embodiment 2 includes the apparatus main body 401A, a sheet feeding portion 430, and the transfer unit 440. Just like Embodiment 1, the fixing apparatus 80 is disposed on the first end portion 1b1 side of the apparatus main body 401A.

The transfer unit 440 includes a belt 441 which conveys a sheet S, four primary transfer rollers 442, a driving roller 446, and a tension roller 447. In the printer 401 according to Embodiment 2, the optical sensor 44, which detects a toner image transferred to the belt 441, is disposed.

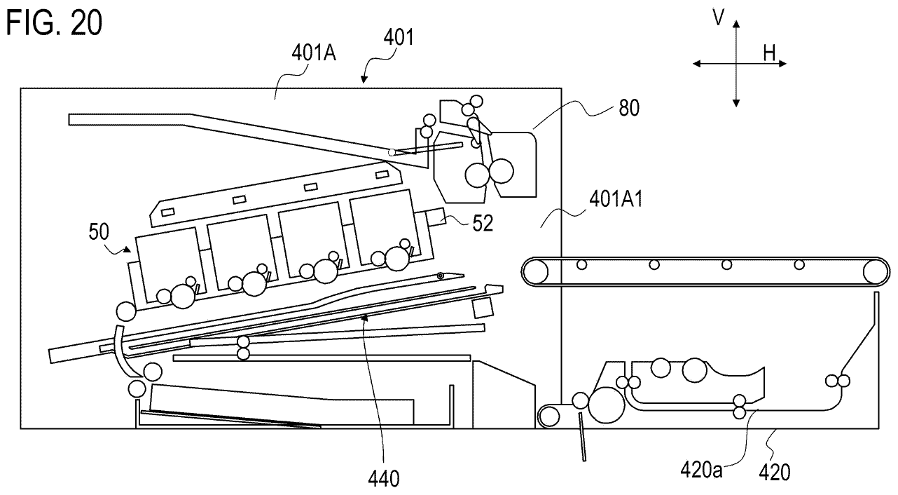

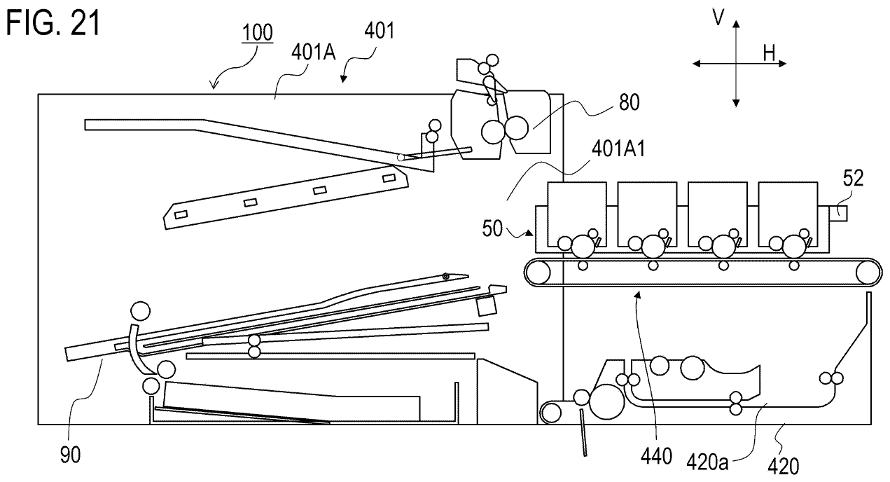

FIG. 20 is a diagram depicting the printer 401 in a state where the transfer unit 440 is moved out alone from the apparatus main body 401A. FIG. 21 is a diagram depicting the printer 401 in a state where the transfer unit 440 and the tray unit 50 are moved out of the apparatus main body 401A. The opening 401A1 is disposed on the first end portion 1b1 side of the apparatus main body 401A. The tray unit 50 and the transfer unit 440 are configured to be movable or drawable from the apparatus main body 401A through the opening 401A1. The door 420 is movable between a closed position where the opening 401A1 is covered, and an open portion where the opening 401A1 is exposed. The door 420 at the open position supports the transfer unit 440 and the tray unit 50, which are moved out of the apparatus main body 401A by a support portion (not illustrated). In Embodiment 2 as well, the fixing apparatus 80 is configured to be movable between the fixing position and the retracting position, and when the tray unit 50 is moved out, the fixing apparatus 80 is retracted from the moving space (moving path) of the tray unit 50.

### Image Forming Operation

An image forming operation of the printer 401 according to Embodiment 2 will be described next. In Embodiment 2, compared with Embodiment 1, the moving path of the sheet S and the method of transferring a toner image to the sheet S are different.

In the image forming operation, a toner image is formed on the photosensitive drum 61 based on the image information, just like Embodiment 1. The sheet S, fed from the sheet feeding portion 430, is held on the belt 441 between the primary transfer roller 442 and the photosensitive drum 61, and is conveyed along the belt 441 in this state. Here transfer voltage is applied to the primary transfer roller 442, and the toner image is transferred from the photosensitive drum 61 to the sheet S. In the image forming operation according to Embodiment 2, the moving direction of the belt 441 and the rotation directions of the driving roller 446 and the tension roller 447 are the opposite of the directions of Embodiment 1.

The sheet S, on which the toner image is transferred, is conveyed toward the fixing apparatus 80, and the toner image is fixed to the sheet S by the fixing apparatus 80.

In the case of single-sided printing, the sheet S, that passed the fixing apparatus 80, is delivered by the flapper 5 to a delivery tray 401f, which is disposed at the upper portion of the apparatus main body 401A. In the case of double-sided printing, the sheet S, reversed by the flapper 5, is transferred onto the belt 441 again from a double-sided conveying path 420a inside the door 420 via a return conveying path, which is disposed above the sheet feeding portion 430. Then the sheet S is conveyed again by the belt 441 to a position contacting the photosensitive drum 61. After the toner image is transferred from the photosensitive drum 61 to the rear face of the sheet S, the sheet S passes the fixing apparatus 80 and is delivered to the delivery tray 401f.

Thus in the printer 401 according to Embodiment 2, the secondary transfer portion is not disposed, and different color toner images are superimposed and transferred to the sheet S directly from the plurality of photosensitive drums 61.

The transfer unit 440 of Embodiment 2 is configured in the same way as the transfer unit 40 of Embodiment 1, except that the transfer unit 440 conveys the sheet S held between the primary transfer roller 442 and the photosensitive drum 61. Specifically, the transfer unit 440 is configured so as to be movable or drawable from the first end portion 1b1 side of the apparatus main body 401A. Therefore, the user can clear a jam, access the fixing apparatus 80, attach/detach the transfer unit 440 and the tray unit 50, and refill the sheets S, from the first end portion 1b1 side of the printer 401.

Further, the transfer unit 440 can be moved out from the apparatus main body 401A together with the tray unit 50, and also can be moved out from the apparatus main body 401A independently from the tray unit 50. In the case where the transfer unit 440 is moved out together with the tray unit 50, the transfer shaft of the transfer unit 440 passes the upper guide region 93 (first path) of the main guide 90. In the case where the transfer unit 440 is moved out independently from the tray unit 50, the transfer shaft of the transfer unit 440 passes the second region 93B of the lower guide region 92 (second path) of the main guide 90.

Furthermore, the regulating structure 70 restricts the tray unit 50 from being moved alone from the apparatus main body 401A. The transfer unit 440, on the other hand, can move alone between inside and outside the apparatus main body 401A, without being regulated by the regulating structure 70.

### Embodiment 3

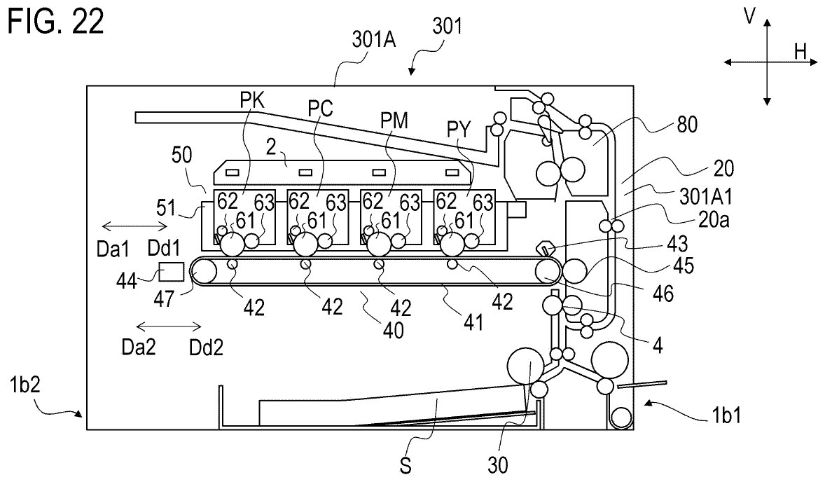

Embodiment 3 of the present disclosure will be described with reference to FIGS. 22, 23, 24, 25, 26 and 27. In the following description on the configuration of Embodiment 3, a composing element the same as Embodiment 1 will be described with a same reference sign, and description thereof will be omitted, and portions characteristic of Embodiment 3 will be mainly described.

### Configuration of Image Forming Apparatus

FIG. 22 is a diagram depicting a general configuration of a printer 301 (image forming apparatus) according to Embodiment 3. The printer 301 (image forming apparatus) according to Embodiment 3 includes an apparatus main body 301A on which an opening 301A1 is formed, and a door 320. The printer 301 corresponds to the printer 1 of Embodiment 1, the apparatus main body 301A corresponds to the apparatus main body 1A of Embodiment 1, and the opening 301A1 corresponds to the opening 1A1 of Embodiment 1 respectively.

In Embodiment 1, the tray unit 50 and the transfer unit 40 are attached to the apparatus main body 1A such that the longitudinal directions thereof are inclined from the horizontal direction. In Embodiment 3, on the other hand, the tray unit 50 and the transfer unit 40 are attached to the apparatus main body 301A such that the longitudinal directions thereof are parallel with the horizontal direction.

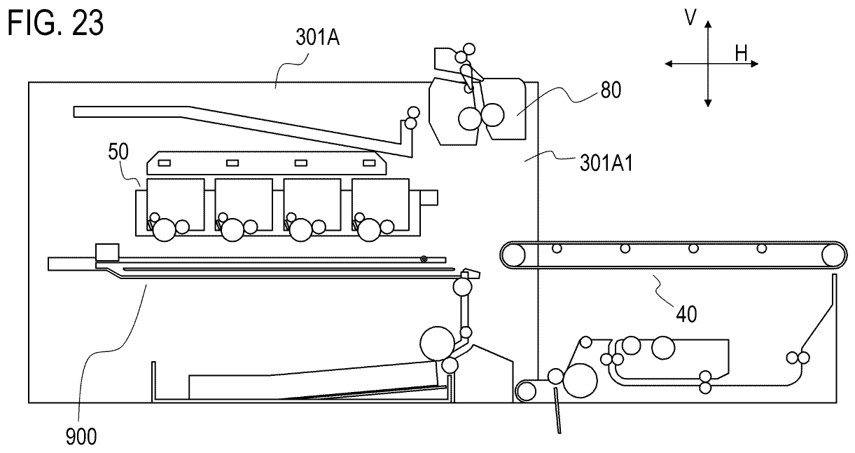

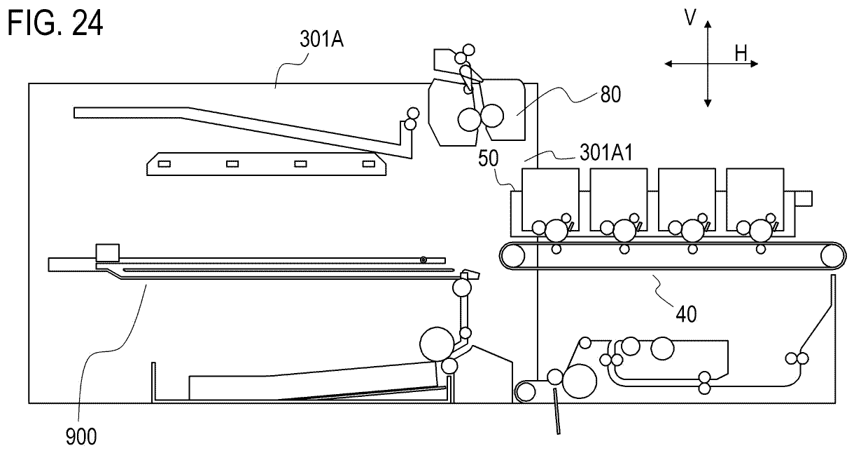

FIG. 23 is a diagram depicting the printer 301 in a state where the transfer unit 40 is moved out alone from the apparatus main body 301A. FIG. 24 is a diagram depicting the printer 301 in a state where the transfer unit 40 and the tray unit 50 are moved out from the apparatus main body 301A. The opening 301A1 is disposed on the first end portion 1b1 side of the apparatus main body 301A.

The tray unit 50 and the transfer unit 40 are configured to be movable or drawable from the apparatus main body 301A through the opening 301A1. The door 420 is movable between a closed position where the opening 301A1 is covered and an open position where the opening 301A1 is exposed. The door 320 at the open position supports the transfer unit 40 and the tray unit 50, which are moved out of the apparatus main body 301A using a support portion (not illustrated). In Embodiment 3 as well, the fixing apparatus 80 is configured to be movable between the fixing position and the retracting position, and the fixing apparatus 80 is retracted from the moving space (moving path) of the tray unit 50 when the tray unit 50 is moved out.

### Moving Path of Transfer Unit

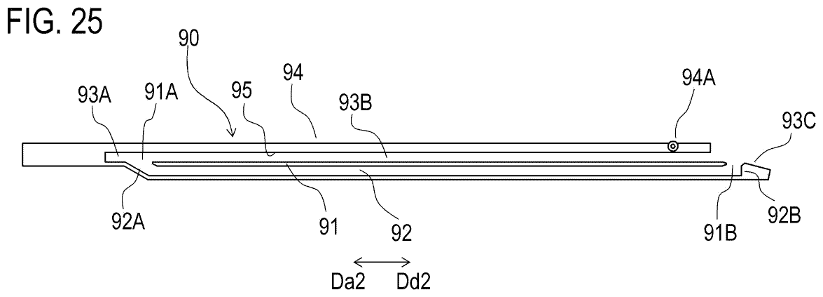

The moving path of the transfer unit 40 will now be described in detail with reference to FIGS. 25, 26 and 27. In Embodiment 3, the tray unit 50 and the transfer unit 40 are moved out of the apparatus main body 301A in the horizontal direction. In other words, the tray unit 50 and the transfer unit 40 move between inside and outside the apparatus main body 301A in the horizontal direction without changing the attitude.

As illustrated in FIGS. 23 and 24, a main guide 900 is installed in the main frame 100. FIG. 25 is a diagram for describing the configuration of the main guide 900. The configuration of the main guide 900 according to Embodiment 3 is approximately the same as the main guide 90 according to Embodiment 1, only in which the curved surface portion 96 is removed, hence detailed description will be omitted.

Moving Path when Transfer Unit Moves Independently from Tray Unit

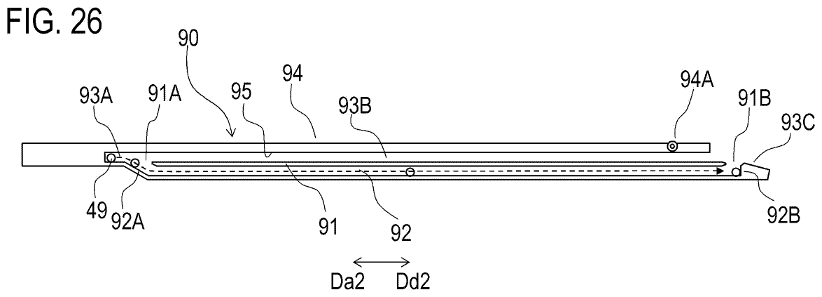

The moving path of the transfer unit 40 when the transfer unit 40 moves independently from the tray unit 50 will be described in detail. FIG. 26 is a diagram for describing the moving path of the transfer unit 40, and the broken line indicates a path (locus) of the transfer shaft 49 when the transfer unit 40 moves from the second inner position to the second outer position independently from the tray unit 50.

When the transfer unit 40 is located at the second inner position, the transfer shaft 49 is located within the first region 93A of the upper guide region 93. As illustrated in FIG. 26, when the transfer unit 40 moves alone from the second inner position to the second outer position, the transfer shaft 49 passes from the first region 93A of the upper guide region 93 of the main guide 90 to the notch portion 91A, then enters the lower guide region 92 along the sloped surface 92A. Then the transfer unit 40 moves in the second detaching direction Dd2 while being guided by the main guide 90, so that the transfer shaft 49 passes the lower guide region 92. If the transfer unit 40 is lifted after the transfer shaft 49 moved until abutting the detent portion 92B, the transfer shaft 49 passes the notch portion 91B, and the transfer unit 40 can be detached from the apparatus main body 1A. The second outer position of the transfer unit 40 is the position where the transfer shaft 49 abuts the detent portion 92B.

When the transfer unit 40 is moved to the second inner position in the state where the tray unit 50 is attached to the apparatus main body 1A, the transfer unit 40 passes the above mentioned moving locus in the opposite direction. In other words, the transfer shaft 49 enters the lower guide region 92 through the notch portion 91B, passes the lower guide region 92 along the extending direction thereof, moves up the sloped surface 92a, and reaches the first region 93A of the upper guide region 93.

As described above, when the transfer unit 40 moves independently from the tray unit 50, the transfer shaft 49 passes the lower guide region 92. Therefore, the transfer unit 40 can move in the second detaching direction Dd2 and the second attaching direction Da2 at a position which is separated from the tray unit 50 in the downward direction. By this configuration, the transfer unit 40 can smoothly move between the second inner position and the second outer position without scratching the photosensitive drum 61.

### Moving Path When Transfer Unit Moves Together With Tray Unit

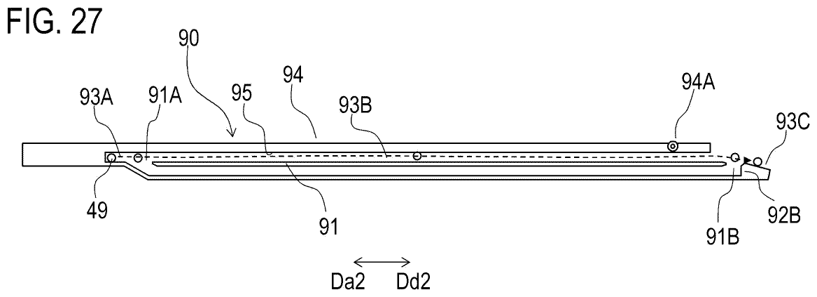

Next the moving path of the transfer unit 40, when the transfer unit 40 moves together with the tray unit 50, will be described in detail. FIG. 27 is a diagram for describing the moving path of the transfer unit 40, and the broken line indicates a path (locus) of the transfer shaft 49 when the transfer unit 40 moves from the second inner position to outside the apparatus main body 1A together with the tray unit 50.

When the tray unit 50, linked with the transfer unit 40, moves from the first inner position to the first outer position, the lower surface of the tray unit 50 is supported by the tray unit support portion 94. The transfer unit 40, on the other hand, moves together with the tray unit 50 while being supported from the bottom by the transfer linking portion 51A of the tray unit 50. Therefore, in the case where the transfer unit 40 moves together with the tray unit 50, the transfer shaft 49 enters the second region 93B without dropping into the lower guide region 92, and moves along the upper guide region 93.

The rotatable roller 94A is disposed at the end portion of the tray unit support portion 94 in the second detaching direction Dd2. Since the tray unit 50 can smoothly move on the roller 94A, load when the user draws out the tray unit 50 can be reduced.

When the center of gravity of the tray unit 50 and the transfer unit 40 is on the downstream side of the roller 94A in the second attaching direction Da2, the tray unit 50 moves while supported by the tray unit support portion 94. Here the tray unit 50 moves while supported by the roller 94A and the surface 94B on the downstream side of the roller 94A in the second attaching direction Da2.

When the center of gravity of the tray unit 50 and the transfer unit 40 is on the downstream side of the roller 94A in the second detaching direction Dd2, the lower surface 51D of the tray unit 50 is separated from the surface 94B of the tray unit support portion 94, and the tray unit 50 moves while supported by the roller 94A. By the transfer shaft 49 contacting the flat surface portion 95, which is the upper surface of the second region 93B of the upper guide region 93, the inclination of the tray unit 50 and the transfer unit 40 during movement is restricted.

If the tray unit 50 and the transfer unit 40 are further moved out in the state where the transfer shaft 49 is located in the second region 93B, the transfer unit 40 is supported by the support portion of the door 20, and the tray unit 50 is supported by the door 20 via the transfer unit 40.

As mentioned above, when the transfer unit 40 moves together with the tray unit 50, the transfer shaft 49 passes the upper guide region 93, and the tray unit 50 can smoothly move between the first inner position and the first outer position.

The configuration indicated in each embodiment described above may be combined with each other as desired.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-037893, filed on Mar. 12, 2024, which is hereby incorporated by reference herein in its entirety.

What is claimed is:

1. An image forming apparatus, comprising:
an apparatus main body including an opening;
a first unit attached to the apparatus main body and configured to be movable from the apparatus main body through the opening; and
a second unit attached to the apparatus main body and configured to be movable from the apparatus main body through the opening, the second unit including an engaged portion, and is configured to be movable from the apparatus main body together with the first unit, and also to be movable from the apparatus main body independently from the first unit; and
an engaging member engaged with the engaged portion in a case where the second unit is moved out from the apparatus main unit body, the engaging member including a first path and a second path branching from the first path, wherein
in a case where the second unit is moved out together with the first unit, the engaged portion passes the first path, and in a case where the second unit is moved out independently from the first unit, the engaged portion passes the second path.

2. The image forming apparatus according to claim 1, wherein
the first path and the second path are grooves, and the engaged portion is a projection which enters at least one of the grooves.

3. The image forming apparatus according to claim 1, wherein
the second path is disposed at a position that is more distant from the first unit located inside the apparatus main body, than the first path is from the first unit located inside the apparatus main body.

4. The image forming apparatus according to claim 1, further comprising:
a restricting portion, wherein in a case where the second unit is moved out independently from the first unit, the restricting portion restricts the engaged portion from entering the first path.

5. The image forming apparatus according to claim 4, wherein
the engaging member includes: a separating portion which separates the first path and the second path; and a connecting portion which connects the first path and the second path, wherein
the second unit includes a contact portion, the contact portion contacts the restricting portion in a case where the second unit is moved out independently from the first unit, and wherein
in a state where the contact portion contacts the restricting portion, a position of the engaged portion overlaps with a position of the connecting portion in a direction where the second unit is moved to outside of the apparatus main body.

6. The image forming apparatus according to claim 5, wherein
the restricting portion includes a sloped surface with which the contact portion contacts, and wherein
the sloped surface is configured to guide the contact portion so that the engaged portion approaches the second path as the second unit is moved to outside of the apparatus main body.

7. The image forming apparatus according to claim 5, further comprising:
a regulating structure configured to restrict the first unit from being moved to outside of the apparatus main body in a state where the contact portion contacts the restricting portion.

8. The image forming apparatus according to claim 1, further comprising:
a restricting portion, wherein in a case where the second unit is inserted into the apparatus main body in a state where the first unit is attached to the apparatus main body, the restricting portion restricts the engaged portion from passing through the first path and reaching a position where the second unit is attached to the apparatus main body.

9. The image forming apparatus according to claim 1, wherein
the second unit is moved out to a first position in a case where the second unit is moved out together with the first unit, and is moved out to a second position in a case where the second unit is moved out independently from the first unit.

10. The image forming apparatus according to claim 9, wherein
the second unit is detachable from the apparatus main body at the second position.

11. The image forming apparatus according to claim 9, wherein
the second position is closer to the apparatus main body than the first position is to the apparatus main body.

12. The image forming apparatus according to claim 1, wherein
the apparatus main body includes an opening/closing member configured to be capable of opening/closing the opening, and wherein
the opening/closing member supports the second unit moved out of the apparatus main body in a state where the opening/closing member is opened.

13. The image forming apparatus according to claim 1, wherein
a part of the second unit is located inside a space through which the first unit passes when the first unit attached to the apparatus main body is moved out.

14. The image forming apparatus according to claim 1, wherein
the first unit is an image forming unit which includes at least one photosensitive member, and the second unit is a belt unit which includes a belt to be contacted with the photosensitive member.

15. The image forming apparatus according to claim 14, wherein
the image forming unit includes a cartridge which includes a developing roller to be contacted with the photosensitive member, and a tray which detachably holds the cartridge.

16. The image forming apparatus according to claim 14, further comprising:
a transfer roller configured to form, with the belt, a transfer nip to transfer an image, which has been transferred from the photosensitive member to the belt, onto a recording material;
a feeding portion configured to feed a recording material to the transfer nip;
a fixing apparatus configured to heat an image transferred by the transfer nip and fix the image to the recording material; and
a conveying portion configured to convey the recording material from the feeding portion to the fixing apparatus through the transfer nip, wherein
the recording material conveyed from the feeding portion to the fixing apparatus passes a space through which the first unit passes when the first unit attached to the apparatus main body is moved out, and a space through which the second unit passes when the second unit attached to the apparatus main body is moved out.

17. The image forming apparatus according to claim 1, further comprising:
a fixing apparatus configured to heat an image transferred onto a recording material and fix the image to the recording material, wherein
the fixing apparatus is configured to be movable between a fixing position which is a position where the image is fixed to the recording material and which overlaps with a space through which the first unit passes when the first unit attached to the apparatus main body is moved out, and a retracting position where the first unit is retracted from the space.

18. The image forming apparatus according to claim 1, further comprising:
a feeding cassette configured to house a recording material and be movable from the apparatus main body, wherein
in a vertical view, a direction in which the feeding cassette is moved out is the same as a direction in which the first unit is moved out of the apparatus main body.
